(19) United States
(12) Patent Application Publication
(10) Pub. No.: US 2026/0195751 A1
(43) Pub. Date: Jul. 9, 2026

(54) SYSTEMS AND METHODS FOR CROSS-COMPUTING ARCHITECTURE TRANSFER MESSAGE TRANSLATION

(71) Applicant: CITIBANK, N.A., New York, NY (US)

(72) Inventors: Aseem AGRAWAL, Singapore (SG); Chirdeep Singh CHHABRA, Singapore (SG); Karim Abdelkader CHABANE, Hong Kong (CN); Miriam SILVER, Tel Aviv (IL)

(73) Assignee: CITIBANK, N.A., New York, NY (US)

(21) Appl. No.: 19/557,626

(22) Filed: Mar. 5, 2026

Related U.S. Application Data
(63) Continuation-in-part of application No. 19/460,108, filed on Jan. 26, 2026.
Application No. 19/460,108 is a continuation of application No. 19/197,841, filed on May 2, 2025, now Pat. No. 12,536,533.
Application No. 19/197,841 is a continuation of application No. 18/596,273, filed on Mar. 5, 2024, now Pat. No. 12,346,905.
Application No. 18/596,273 is a continuation of application No. 17/498,622, filed on Oct. 11, 2021, now Pat. No. 11,935,052.

(51) Int. Cl. G06Q 20/40; G06F 16/27; G06Q 20/36; G06Q 20/38

(52) U.S. Cl. CPC G06Q 20/401; G06F 16/27; G06Q 20/36; G06Q 20/3829; G06Q 2220/00

(57) ABSTRACT

A distributed ledger technology application can establish a first connection with a computing application executed by a banking computing infrastructure and a second connection with one or more nodes hosting a distributed ledger via a second communication protocol. The application can receive, from a client device through the through the first connection using the first communication protocol, a receive instruction to complete an asset transfer to transfer an asset from a source account hosted in the banking computing infrastructure to a DLT-based client account. The application can execute an asset conversion agent to determine whether any asset conversion is required. The application can execute an instruction generation agent to generate a new receive instruction. The application can execute a ledger agent to generate an instruction to cause the one or more nodes to add a record of the asset transfer to the distributed ledger.

### CROSS-REFERENCE TO RELATED APPLICATIONS

This application claims the benefit of priority as a continuation-in-part to U.S. Patent Application No. 19/460,108, filed January 26, 2026, which claims the benefit of priority as a continuation to U.S. Patent Application No. 19/197,841, filed May 2, 2025, which claims the benefit of priority as a continuation to U.S. Patent Application No. 18/596,273, filed March 5, 2024, which the claims the benefit of priority as a continuation to U.S. Patent Application No. 17/498,622, filed October 11, 2021, the entirety of each of which is incorporated by reference herein.

### TECHNICAL FIELD

This application relates generally to a single platform that enables processing single and multi-asset transactions using distributed ledger technology (DLT) while providing seamless integration with assets held on legacy infrastructure.

### BACKGROUND

As the processing power of computers allows for greater computer functionality and the Internet technology era allows for interconnectivity between computing systems, many institutions are shifting towards DLT-based technology to store and maintain the integrity of transaction data as well as to achieve transactional efficiency and to address some of the limitations inherent in current infrastructure for financial transactions. Some of these limitations include (a) transfers of most financial assets involve delays and are usually not available 24x7; (b) fragmentation of ledgers and transfer protocols for different asset types introduce operational complexity both for clients and service providers; and (c) there is no generic infrastructure for making contingent or concurrent payments between two or more parties. While DLT-based storage methods may require more computational resources than conventional methods (e.g., a central database), the immutability of the data within the DLT enables operators to have peace of mind that the data in the DLT is accurate and may not be changed.

With DLT-based storage methods being in relative infancy, a vast majority of asset balances for traditional (non-crypto) assets are held on conventional (non-distributed) ledgers (e.g., a static database). Even if some users move part or all of their asset balances to a distributed ledger, at least some of their transactions may involve transfers to or from accounts which are held on conventional ledgers (i.e., “conventional accounts”). Transfers from and/or to such conventional accounts often involve steps which are different from steps involved in transferring assets between non-conventional accounts. Furthermore, users, especially institutional (non-individual), may have existing systems and processes designed to work with conventional ledgers, and there may be significant integration work, and process revision required for them to adopt DLT-based solutions even for a small part of their holdings. With regulatory frameworks and accounting policies on the treatment of assets held on DLT’s still evolving across the world, institutional users operating in multiple jurisdictions may additionally need to undertake regulatory/accounting analysis before adoption of such solutions, and to establish that the asset on the distributed ledger (the ‘token’) is not seen as a new security (just as any depository receipt is) issued by an issuer different from the issuer of the original asset. All these hurdles may have the impact of slowing down the adoption of DLT-based solutions by institutional users, except for specialized use cases involving a limited number of participants, where the benefits from the use case may justify changes to a limited number of existing systems by all of them to on-board the solution.

Existing solutions for DLT-based assets need to contend with the above issues, and may also suffer additional shortcomings. For example, solutions work well for entities which agree up front to accept the token; they would all be able to execute such transfers efficiently amongst themselves, (e.g., previous solutions may work well for a “closed user group”). However, when an entity receives a token from any of its counterparties, but is unable to find another counterparty within the “closed group” to immediately deploy it to, the entity may need to keep the token until it finds a counterparty to post it to. Inability to use the tokens immediately would lead to increased funding costs being borne by the entity. This further reduces the likelihood of adoption of the token. Another shortcoming is that many of the solutions are for single asset classes or just a single asset (USDC for USD cash). They therefore are not in a position to effect conditional or concurrent multi-asset transfers.

Users may not be able to transfer funds between traditional accounts and cryptographic wallets seamlessly because these account types use incompatible protocols and processes. For instance, in the DLT-based world, wallets may be accessed through cryptographic keys or a wallet interface. In the conventional account world, accounts are accessed via conventional interfaces (graphical user interface or API) or via channels like SWIFT over which messages in standard (e.g., conventional) formats like ISO15022 or ISO20022 may be sent. In the current environment, these communication protocols and channels are distinct and don’t support using an integrated approach. Consequently, two users that have DLT-based and conventional accounts respectively may not be able to execute transactions between each other seamlessly, even if they desire to do so.

### SUMMARY

For the aforementioned reasons, there is a need for a method and system that enables users to instruct standard transactions on their DLT-based account using conventional interfaces, not needing to undertake any operational or technical enhancements to access basic details of their transactions and balances across one or more asset classes (in which they hold balances), and being able to move assets to and receive assets from conventional accounts (for one or more asset classes) seamlessly and without adding any material processing time. In other words, the method and system should, in addition to providing a wallet and cryptographic key access, give clients the option to operate their DLT wallets in the same way as conventional accounts so that usage of the new platform can be completely transparent from an on-boarding and operating perspective, for transactions types which are available in the conventional world.

The methods and systems described herein aim to provide functionality that enables the above. The method may use an intermediary application that is set up with its own routing address used in conventional transaction infrastructure (e.g., BIC code) to and from which clients can route messages using conventional protocols (e.g., via SWIFT). As described herein, references to a BIC code should be understood to mean a routing address used in a conventional transaction infrastructure. Further, as described herein, references to SWIFT should be understood to mean any financial message service providers. Similarly, a SWIFT authentication key should be understood to be an authentication key for any financial message service in use. The intermediary application may link an account in the conventional infrastructure (e.g., cash account provided by a bank, or securities account provided by a custodian) to one or more client accounts on the DLT (a.k.a. wallets), with the balance on the conventional account matching the aggregate of client balances on the linked wallets for that particular asset; with any external transfer from the conventional account only permitted to be initiated by the intermediary application. In some cases, a conventional account may link to multiple accounts, in which case the conventional account may be an omnibus account. Every DLT wallet may have a wallet identification. For every DLT wallet identification, the intermediary application may maintain a mapping to one or more client-specific conventional account identifications (when a conventional account links to a single wallet, then the identification of that conventional account maps to the wallet identification). For example, wallets may be mapped to conventional accounts in a many-to-one or a one-to-one mapping for any given asset (one wallet would only map to one conventional account for UST holdings, one wallet would only map to one cash account for USD, etc.). When the conventional account is an omnibus account mapping to multiple wallets, then the conventional account identification mapped to wallet identifications would not correspond to any account in the conventional infrastructure. In this case, the DLT may act as a sub-ledger and maintain the golden source of client balances which may not be available in conventional infrastructure.

The intermediary application may have the ability to process conventional messages to carry out asset transfers within the DLT, as well as from conventional accounts onto the DLT, and from the DLT to conventional accounts, as well as to process other conventional messages involved in the transaction lifecycle. As described herein, such processing may include processing of received messages, as well as creation of any new messages. The intermediary application may be permissioned to manage client’s cryptographic keys mapped against their unique SWIFT authentication key and/or BIC code. The intermediary application may have the ability to generate standard transaction status messages used in conventional transactions, standard debit and credit confirmation, standard end-of-day balance and transaction reports, and to send these messages via conventional messaging statuses on the wallet and via conventional messaging. The intermediary application may have the capability to let clients use conventional messaging/means and wallets for different components of the same transaction. A cryptographic wallet may provide a private key to the intermediary application, allowing wallet holders one channel to convey instructions to the platform. Thus, the intermediary application can enable all the features listed earlier.

A method for seamlessly processing transactions using distributed ledger technology, comprising: linking, by a distributed ledger technology (DLT) application executed or hosted by one or more processors, one or more conventional accounts hosted in a conventional computing system (i.e., various kinds of accounts provided by licensed financial institutions such as central banks, commercial banks, custodians, payment banks, etc.) to one or more DLT-based client accounts hosted on a distributed ledger, wherein a balance on each of the one or more conventional accounts matches an aggregate of client balances on one or more DLT-based client accounts for an asset of a first asset type, and wherein any external transfers originating at one of the one or more conventional accounts are only permitted to be initiated by the DLT application, wherein the DLT application comprises a routing address configured to be used in conventional transaction infrastructure to and from which client devices and/or financial institutions can route messages using conventional communication protocols; storing, by the DLT application, one or more wallet identifications for the one or more DLT-based client accounts and a mapping of the one or more wallet identifications to the one or more conventional accounts hosted in the conventional computing system; wherein the DLT application is permissioned to manage cryptographic keys for the one or more DLT-based client accounts mapped against corresponding authentication keys and/or routing addresses; wherein the DLT application is configured to receive, process, create, and send, to and from client devices, conventional messages for asset transfer between the one or more conventional accounts and the one or more DLT-based client accounts or between the one or more DLT-based client accounts, the asset transfers of a plurality of asset types; wherein the DLT application is configured to receive, process, create, and send, to and from financial institutions, messages for asset transfers; exchanging, by the DLT application, a sequence of messages to execute an asset transfer and complete a transaction lifecycle, the sequence of messages based on the first asset type; and updating, by the DLT application, the distributed ledger based on the asset transfer. Updating the distributed ledger may include updates both during the asset transfer and at the end of the asset transfer (e.g., in the process of detokenization, locking a token initially, and/or burning a token subsequently).

A system for seamlessly processing transactions using distributed ledger technology, the system comprising: an application server comprising a processor executing or hosting a distributed ledger technology (DLT) application, the processor configured to execute or host the DLT application to: link one or more conventional accounts hosted in a conventional computing system (i.e., various kinds of accounts provided by licensed financial institutions such as central banks, commercial banks, custodians, payment banks, etc.) to one or more DLT-based client accounts hosted on a distributed ledger, wherein a balance on each of the one or more conventional accounts matches an aggregate of client balances on one or more DLT-based client accounts for an asset of a first asset type, and wherein any external transfers originating at one of the one or more conventional accounts are only permitted to be initiated by the DLT application, wherein the DLT application comprises a routing address configured to be used in a conventional transaction infrastructure to and from which client devices and/or financial institutions can route messages using conventional communication protocols; store one or more wallet identifications for the one or more DLT-based client accounts and a mapping of the one or more wallet identifications to the one or more conventional accounts hosted in the conventional computing system; wherein the DLT application is permissioned to manage cryptographic keys for the one or more DLT-based client accounts mapped against corresponding authentication keys and/or routing addresses; wherein the DLT application is configured to receive, process, create, and send, to and from client devices, conventional messages for asset transfers between the one or more conventional accounts and the one or more DLT-based client accounts or between the one or more DLT-based client accounts, the asset transfers of a plurality of asset types; wherein the DLT application is configured to receive, process, create, and send, to and from financial institutions, messages for asset transfers; exchange a sequence of messages to execute an asset transfer and complete a transaction lifecycle, the sequence of messages based on the first asset type; and update the distributed ledger based on the asset transfer.

In one embodiment, a method for tokenization comprises establishing, by a DLT-application executed or hosted by an application server, a connection between the DLT-application and a second application (or group of applications) executed or hosted by server(s) maintained by a financial institution, the DLT-application storing a plurality of digital wallets connected to a distributed ledger and the second application storing a plurality of conventional accounts linked to the plurality of digital wallets (i.e., the DLT-application maintains a mapping of the plurality of wallets to the plurality of conventional accounts); responsive to a transaction request from a first client device, receiving, by the DLT-application from the second application, confirmation of a credit into the recipient account; responsive to receiving the confirmation, transmitting, by the DLT-application to one or more computing devices of the distributed ledger, instructions to update the distributed ledger crediting a destination account based on the transaction; and sending, by the DLT application, a credit confirmation, end of day messages, and other status messages to the first client device.

In another embodiment, a system for tokenization, the system comprises an application server comprising a processor executing a DLT-application, the processor configured to execute or host the DLT-application to establish a connection between the DLT-application and a second application executed by server(s) maintained by a financial institution, the DLT-application storing a plurality of digital wallets connected to a distributed ledger and the second application storing a plurality of conventional accounts linked to the plurality of digital wallets (i.e., the DLT-application maintains a mapping of the plurality of wallets to the plurality of conventional accounts); responsive to a transaction request from a first client device, receive, from the second application, confirmation of a credit into the recipient account; responsive to receiving the confirmation, transmitting, to one or more computing devices of the distributed ledger, instructions to update the distributed ledger crediting a destination account based on the transaction; and sending, by the DLT application, a credit confirmation, end of day messages, and other status messages to the first client device.

In another embodiment, a method for detokenization comprises establishing, by a DLT-application executed or hosted by an application server, a connection between the DLT-application and a second application executed by server(s) maintained by a financial institution, the DLT-application storing a plurality of digital wallets connected to a distributed ledger and the second application storing a plurality of conventional accounts linked to the plurality of digital wallets; receiving, by the DLT-application, a transaction request from a first client device identifying a token; freezing, by the DLT-application, the token; responsive to receiving the transaction request, transmitting, by the DLT-application, a deliver instruction identifying the source account and a destination account to the second application; receiving, by the DLT-application from the second application, confirmation of a debit from the source account; and responsive to receiving the confirmation from the second application, transmitting, by the DLT-application to one or more computing devices of the distributed ledger, instructions to update the distributed ledger debiting the source account based on the token; and sending, by the DLT application, a debit confirmation, end of day messages, and other status messages to the first client device.

In another embodiment, a system for detokenization, the system comprises an application server comprising a processor executing or hosting a DLT-application, the processor configured to execute or host the DLT-application to establish a connection between the DLT-application and a second application executed by server(s) maintained by a financial institution, the DLT-application storing a plurality of digital wallets connected to a distributed ledger and the second application storing a plurality of conventional accounts linked to the plurality of digital wallets; receive a transaction request from a first client device identifying a token; freezing, by the DLT-application, the token; responsive to receiving the transaction request, transmit a deliver instruction identifying the source account and a destination account to the second application; receiving, by the DLT-application from the second application, confirmation of a debit from the source account; and responsive to receiving the confirmation, transmit, to one or more computing devices of the distributed ledger, instructions to update the distributed ledger debiting the source account based on the token; and send a debit confirmation, end of day messages, and other status messages to the first client device.

In another embodiment, a method for token transfers comprises receiving, by a DLT-application, a transaction request from a first client device, the transaction request identifying one or more tokens of one or more distinct assets; validating, by the DLT-application, the transaction request; receiving, by the DLT-application, matching instructions from a second client device; validating, by the DLT-application, the matching instructions; matching, by the DLT-application, the transaction request and the matching instructions; waiting, by the DLT-application, for any specified pre-conditions for the transaction request to be satisfied; settling, by the DLT-application, the transaction; optionally, transmitting, by the DLT-application, messages to a financial account for crediting or debiting the appropriate conventional accounts based on the transaction; and sending, by the DLT application, a debit or credit confirmation, end of day messages, and other status messages to the first client device and/or a second client device associated with the asset transfer.

In another embodiment, a system for token transfers, the system comprises an application server comprising a processor executing or hosting a DLT-application, the processor configured to receive a transaction request from a first client device, the transaction request identifying one or more tokens of one or more distinct assets; validate the transaction request; receive matching instructions from a second client device; validating, by the DLT-application, the matching instructions; match the transaction request and the matching instructions; waiting, by the DLT-application, for any specified pre-conditions for the transaction request to be satisfied; settle the transaction; optionally, transmit messages to a financial account for crediting or debiting the appropriate conventional accounts based on the transaction; and send a debit or credit confirmation, end of day messages, and other status messages to the first client device and/or a second client device associated with the asset transfer.

In another embodiment, a method for seamlessly processing transactions using distributed ledger technology is described herein. The method can be performed, for example, by one or more processors coupled to non-transitory memory. The method can include establishing, by a distributed ledger technology (DLT) application executed or hosted by one or more processors, (i) a first connection with a banking computing application executed by a banking computing system, and (ii) a second connection with one or more nodes hosting a distributed ledger via a second communication protocol. The method can include receiving, from a client device through the first connection using the first communication protocol, a receive instruction to complete an asset transfer to transfer an asset from a source account hosted in the banking computing system to a DLT-based client account, the receive instruction comprising an identifier of the source account and an identifier of the DLT-based client account. The method can include executing an asset conversion agent to determine whether any asset conversion is required to complete the transfer between the banking computing system and the distributed ledger. The method can include, responsive to the asset conversion agent determining an asset conversion is required, executing an instruction generation agent to generate a new receive instruction comprising an identification of a destination account replacing the DLT-based client account from the receive instruction, the identifier of the source account, and the asset being transferred to the destination account, the new receive instruction configured for transmission to the banking computing application executed by the banking computing system to complete the asset transfer. The method can include receiving, over the established first connection and via the first communication protocol, an indication of completion of the asset transfer from the banking computing application. The method can include executing a ledger agent to generate an instruction to cause, over the established second connection and via the second communication protocol, the one or more nodes maintaining the distributed ledger to add a record of the asset transfer to the distributed ledger, thereby updating the DLT-based client account.

In another embodiment, a system for seamlessly processing transactions using distributed ledger technology is described herein. The system can include an application server comprising a processor executing or hosting a distributed ledger technology (DLT) application. The system can establish (i) a first connection with a banking computing application executed by a banking computing system, and (ii) a second connection with one or more nodes hosting a distributed ledger via a second communication protocol. The system can receive, from a client device through the first connection using the first communication protocol, a receive instruction to complete an asset transfer to transfer an asset from a source account hosted in the banking computing system to a DLT-based client account, the receive instruction comprising an identifier of the source account and an identifier of the DLT-based client account. The system can execute an asset conversion agent to determine whether any asset conversion is required to complete the transfer between the banking computing system and the distributed ledger. The system can, responsive to the asset conversion agent determining an asset conversion is required, execute an instruction generation agent to generate a new receive instruction comprising an identification of a destination account replacing the DLT-based client account from the receive instruction, the identifier of the source account, and the asset being transferred to the destination account, the new receive instruction configured for transmission to the banking computing application executed by the banking computing system to complete the asset transfer. The system can receive, over the established first connection and via the first communication protocol, an indication of completion of the asset transfer from the banking computing application. The system can execute a ledger agent to generate an instruction to cause, over the established second connection and via the second communication protocol, the one or more nodes maintaining the distributed ledger to add a record of the asset transfer to the distributed ledger, thereby updating the DLT-based client account.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification, illustrate an embodiment of the invention, and together with the specification, explain the invention.

FIG. 1 illustrates an implementation of a computer system for seamlessly processing transactions using distributed ledger technology, according to an embodiment.

FIG. 2 illustrates a flowchart of a process for tokenization, according to an embodiment.

FIG. 3 illustrates a flowchart of a process for detokenization, according to an embodiment.

FIG. 4 illustrates a flowchart of a process for token transfer, according to an embodiment.

FIG. 5 illustrates an implementation of a computer system for seamlessly processing transactions using distributed ledger technology using an agentic system, according to an embodiment.

FIG. 6 illustrates a flowchart of a process for seamlessly processing transactions using distributed ledger technology using an agentic system, according to an embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Financial institutions can operate a variety of systems to process asset transfers, including conventional banking computing infrastructure that maintains account balances on centralized ledgers and distributed ledger technology (DLT) networks that maintain account balances across decentralized nodes. Conventional banking infrastructure can use established communication protocols such as SWIFT messaging, ISO15022, or ISO20022 to exchange transaction instructions between financial institutions and settlement networks. DLT networks can use blockchain-based protocols to maintain immutable records of transactions and account balances. Financial institutions may maintain accounts for clients in both conventional infrastructure and on DLT networks.

However, conventional approaches to integrating DLT-based account systems with legacy banking infrastructure can introduce significant operational challenges. Asset transfers between conventional accounts and DLT-based accounts can require clients to use different communication protocols, interfaces, and account identifiers for each system. A client operating a conventional account may use SWIFT messaging to initiate transfers within conventional infrastructure, but may need to use a separate cryptographic wallet interface to access a DLT-based account. The disparity between communication protocols and interfaces can prevent clients from executing transactions seamlessly between conventional accounts and DLT-based accounts. Conventional approaches may require clients to modify existing operational systems or integrate new interfaces across multiple systems.

The techniques described herein can provide an intermediary application (e.g., a DLT application) that can bridge conventional banking infrastructure and DLT networks to enable seamless asset transfers. The intermediary application can establish connections with both conventional banking computing systems and nodes hosting a distributed ledger. The intermediary application can maintain or otherwise be associated with a routing address (e.g., a BIC code) that can be used to route messages to and/or from the intermediary application. The intermediary application can receive transaction instructions from client devices using conventional communication protocols and translate the instructions into operations on the distributed ledger. By providing a unified interface for both conventional and DLT-based accounts, the techniques described herein can allow clients to execute transactions across both systems without changing the underlying communication protocols of either system.

The intermediary application can maintain a mapping between DLT-based client accounts and conventional accounts hosted in banking computing infrastructure. The intermediary application can receive a transaction instruction from a client device using a conventional communication protocol such as SWIFT messaging. The intermediary application can use the mapping to identify a destination account within the conventional banking infrastructure and generate a new receive instruction that specifies the identified destination account in the conventional infrastructure. The intermediary application can transmit the new received instruction to the banking computing infrastructure to complete the asset transfer. Upon receiving confirmation that the asset transfer has been completed in the conventional infrastructure, the intermediary application can generate an instruction for nodes maintaining the distributed ledger to add a record of the transaction, thereby updating the DLT-based client account.

Implementing the systems and methods described herein can overcome the interoperability challenges that prevent seamless integration of conventional banking infrastructure and DLT networks. By maintaining mappings between conventional accounts and DLT-based accounts and translating instructions between different communication protocols, the intermediary application can eliminate the need for clients to modify existing operational systems or use separate interfaces for conventional and DLT-based transactions. Clients can initiate transactions to or from DLT-based accounts using the same conventional messaging protocols and interfaces used for conventional accounts. The techniques described herein can facilitate interoperability between legacy banking infrastructure and distributed ledger technology without requiring application-specific modifications to downstream systems.

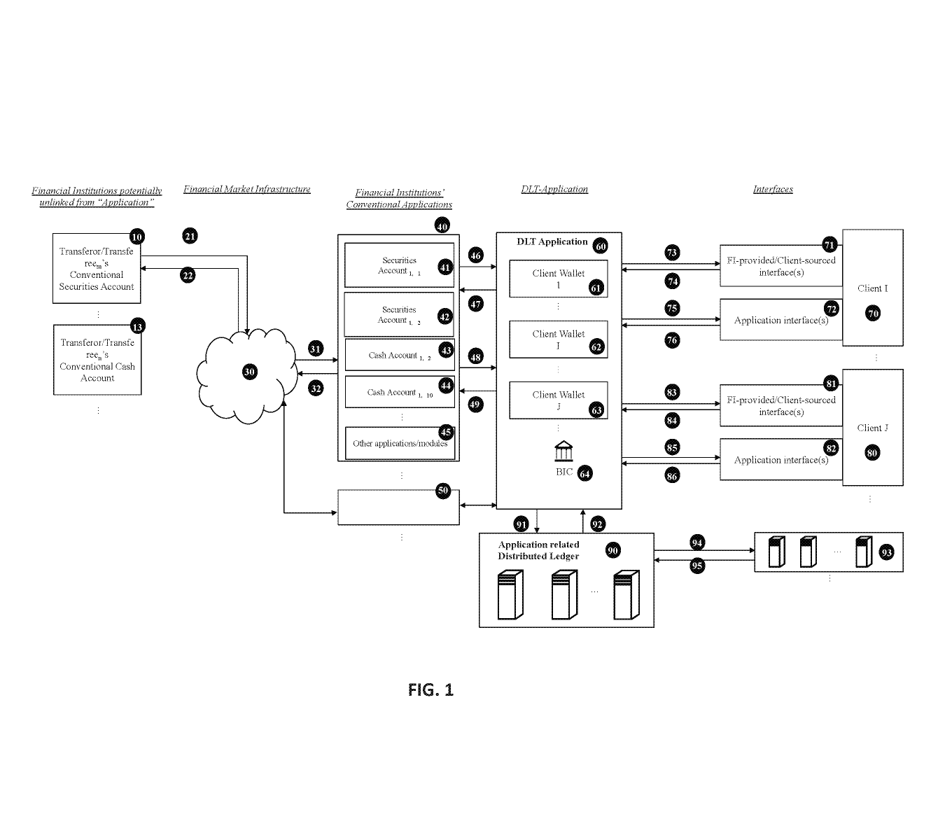

FIG. 1 illustrates various components of a system 100 that enables users to instruct standard transactions on their DLT-based account using conventional and DLT application-specific interfaces, in accordance with an embodiment. The system 100 provides a non-limiting example of a computer system that contains a DLT application with a BIC code to which a client device may route messages via a conventional messaging protocol (e.g., SWIFT). The DLT application may store a plurality of wallets for individual users. The DLT application may be able to communicate with a series of in-network and out of network distributed ledgers to maintain the balances for each of the stored wallets and enable the user to perform transactions with conventional user accounts.

The system may include a financial market infrastructure (“FMI”) 30. The FMI 30 may include depositories and central banks and include a series of servers and processors that coordinate to facilitate transactions. The FMI 30 may enable different financial institutions to settle financial obligations between different user accounts and/or financial entities (e.g., user accounts of the same or different banks). However, it should be noted that transfers do not always need to go through the FMI 30.

The system may include transferor/transferee accounts 10-13. While only two transferor/transferee accounts are shown in FIG. 1, the system 100 may include any number of such accounts. The transferor/transferee accounts 10-13 may be accounts from which assets are transferred and/or accounts that receive such assets. A transferor account may be an account in which an asset is transferred to a conventional account stored in the set of applications 40 and a transferee account may be an account to which an asset is transferred from a conventional account in the set of applications 40. The transferor/transferee accounts 10-13 may be conventional user financial accounts (e.g., accounts stored in a static database) that are stored on the servers of their respective financial institutions and that keep records of asset ownership by the respective account’s owners. In one non-limiting example, the transferor/transferee account 10 may be a conventional securities account and the transferor/transferee account 13 may be a conventional cash account (e.g., an account for holding fiat currency balances such as a Demand Deposit Account offered by a commercial bank). The accounts may perform asset transfers through the FMI 30 or through another network or infrastructure.

In some cases, to perform any transfers, the transferor/transferee accounts 10 or 13 may transfer the securities or money to accounts that are stored on one or more financial institutions’ set of financial applications 40 or 50. For instance, the financial institutions’ sets of financial applications 40 and 50 may each include one or more applications for different financial assets that store conventional accounts 41-44. The conventional accounts 41 and 42 may be securities accounts and conventional accounts 43 and 44 may be cash accounts. While only four accounts are shown, the sets of financial applications 40 and 50 may include any number of accounts for any type of asset. The conventional accounts 41-44 can store assets received from the transferor/transferee accounts 10 and 13 and transfer assets to such accounts. A DLT application 60 may have established connections with the sets of financial applications 40, 50, and/or any number of other applications of other financial institutions.

In one example, the transferor/transferee account 10 may send an instruction 21 to the FMI 30 for an asset transfer to/from an application-linked conventional account 41 (e.g., an application linked to the DLT application 60) of the set of financial applications 40. As described herein, actions by transferor/transferee accounts 10-13 should be understood to mean actions by the owner or authorized operator of the respective account. The FMI 30 may then send one or more instructions 31 that correspond to the instruction 21 to the conventional account 41. The set of financial applications 40 may then transmit one or more instructions 32 to the FMI 30 confirming the status of the transfer to account 41; the FMI may in turn transmit a corresponding instruction 22 to transferor account 10. The instructions and messaging of the sets of instructions 21, 22, 31, and 32 may be transmitted using conventional communication channels such as SWIFT using standards like ISO15022 or ISO20022.

In some cases, a transferor account and/or a transferee account may be stored on the set of financial applications 40 (i.e., transferors and transferees hold accounts at the financial institution that has a set of financial applications that are coupled with the DLT application 60). In such cases, transactions may be performed without transmitting any messages through the FMI 30.

The sets of financial applications 40 and 50 may be applications that are hosted by servers or other computing devices of different financial institutions. For example, the set of financial applications 40 may store accounts for different types of assets (e.g., securities accounts 41 or 42, or cash or demand deposit accounts 43 or 44). The set of financial applications 40 may also include other applications 45 which may include accounting modules, sanctions screening, reconciliation report uploading, reference and pricing data for assets, etc. The DLT application 60 may integrate with the other applications 45 to avoid duplicating their functionality within the DLT application 60. In another embodiment, the DLT application 60 would build some or all these modules itself or rely on third party modules instead of integrating with the other application 45.

As briefly mentioned above, conventional securities account 41 and 42 may be linked to the DLT application 60. The accounts 41 and 42 may hold one or more than one kind of security. One or more of the conventional securities accounts 41 and 42 may serve as omnibus accounts (wherein the holdings in these accounts map to the holdings of multiple underlying user accounts; in which case a DLT network 90 may operate as a sub-ledger for balances held by client wallets, with the aggregate balances matching the assets held in the corresponding omnibus accounts from amongst the accounts 41 and 42). In other cases, one or more of the accounts 41 and 42 may belong to individual end clients (e.g., clients operating client device 70 or client device 80, described below), and map one-to-one to the account balances held on the DLT network 90 (e.g., the DLT application 60 may maintain DLT wallets 61-63 that maintain a record of the current balance for different client accounts (e.g., 41 and 42)). The DLT application 60 may be authorized to convey instructions to accounts 41 and 42, and to receive status messages and other notifications on these accounts. In some instances, the accounts 41 and 42 may have restrictions so that transfers to other conventional accounts can only be instructed via the DLT application 60. The cash accounts 43 and 44 may operate similarly to the accounts 41 and 42, but may store balances for cash instead of securities. In some embodiments, securities accounts may be omnibus accounts, as described herein, and cash accounts may be per client accounts.

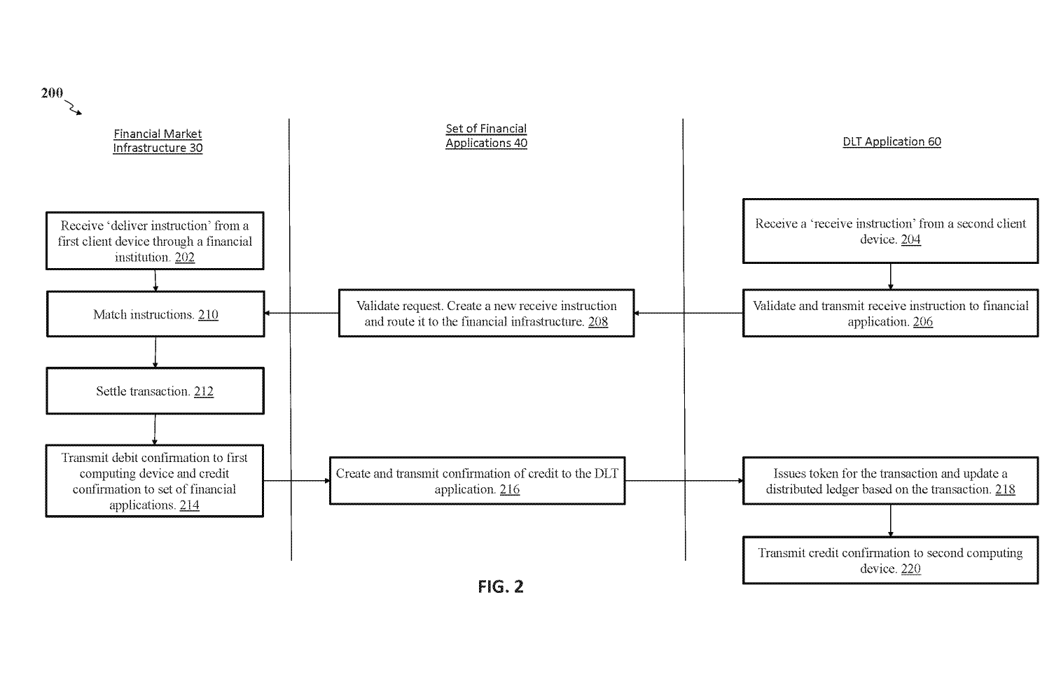

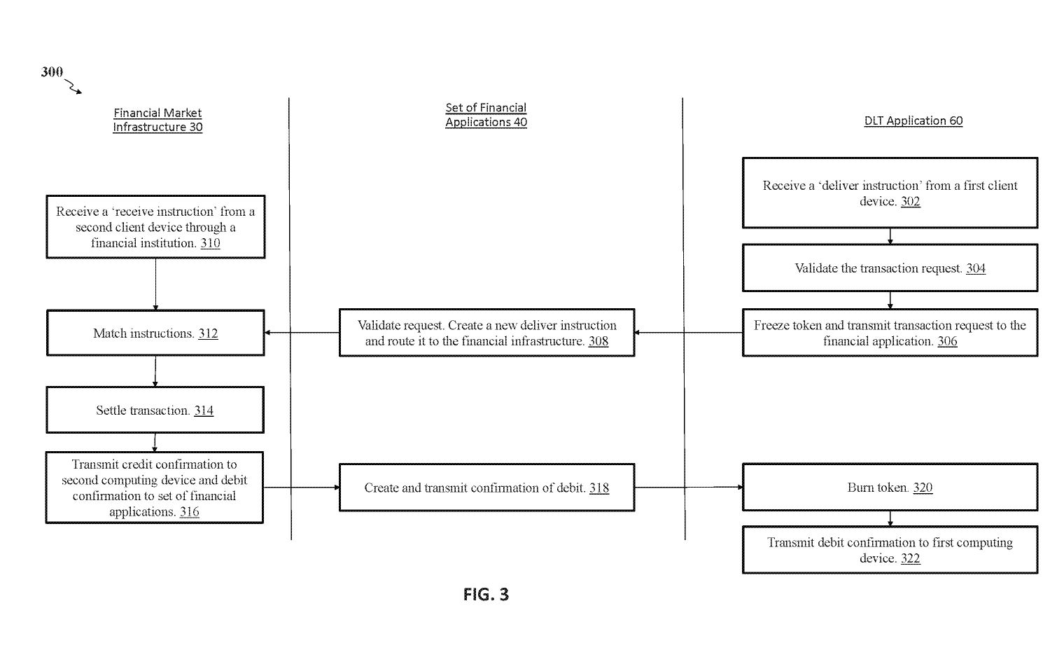

The DLT application 60 may be an application that is configured to accept and process one or more of tokenization, detokenization, and token transfer instructions. As described herein, tokenization refers to creation of an asset on the distributed ledger. In the case of conventional securities or cash, this is on the back of an asset received in a conventional ledger. In the case of omnibus accounts represented on a conventional ledger, a credit into an omnibus account leads to a credit into one of the multiple wallets the balances of which together add up to the balance in the omnibus account. Detokenization refers to destroying an asset on the distributed ledger. In the case of cash and conventional securities, this is usually accompanied by debiting of an asset from a token in a conventional ledger (the sequence of the two debits could change depending on the process). These processes are described in detail below with respect to FIGS. 2 and 3. Token transfers refers to transferring tokens from one account to another account.

The DLT application 60 may, in addition, connect with the conventional accounts 41-44 and other conventional financial applications (e.g., other applications 45). The DLT application 60 may be stored on a server external to any financial institution network and operate as an intermediary application, a ledger (e.g., a distributed ledger), middleware, or a combination of middleware and a ledger between client devices (e.g., the client device 70 or the client device 80) and financial institution applications (e.g., the set of financial applications 40 or the set of financial applications 50). For instance, the DLT application 60 may have or be associated with its own routing address (e.g., a BIC code 64) that can be used to route messages in a conventional financial network. When performing transactions, client devices may include the BIC code 64 in a message header to indicate to route the messages for the transaction to the DLT application 60.

The DLT application 60 may include DLT wallets 61, 62, and 63. The DLT application 60 may include any number of wallets. The DLT wallets 61, 62, and 63 may maintain the balances of the assets that their respective owners have on the DLT network 90 and/or another distributed ledger that may be outside of the financial institution network. The DLT application 60 may update the DLT wallets 61, 62, and 63 periodically based on tokenization, detokenization, token transfers or any other authorized transactions that the clients perform through their respective accounts.

For assets for which the DLT network 90 operates as a sub-ledger, the DLT wallets 61, 62, and 63 may be the ‘golden source’ of client balances given the standard immutability of distributed ledger technology. The DLT wallets 61, 62, and 63 may be mapped (e.g., have a stored relationship in a relational database) to one of more account numbers for the different assets. In cases where a client-specific conventional account is used (in the set of financial applications 40 or the set of financial applications 50), the conventional account number may be mapped to the wallet (e.g., mapped to an identification of the wallet). For all assets where omnibus accounts are used (in the set of financial applications 40 or the set of financial applications 50), the same client account number could be used (but there may be different numbers for different omnibus accounts) to track sub-ledger balances across different conventional omnibus accounts. This account number, like any conventional account, along with the BIC code 64 for the DLT application 60 can be used to route transactions correctly. This (same) client account number could also be the wallet identification, or may have a one-to-one mapping with the wallet identification.

Advantageously, because of the client account number assigned to each wallet, the BIC code assigned to the DLT application 60, and the ability of the DLT application 60 to process incoming conventional messages sent via the Swift network and to generate outgoing messages, clients can configure new accounts on their internal systems using the BIC code 64 and a client account number mapping to their respective wallets (with such mapping being stored in the DLT application 60) just as they would for any other conventional account they hold at a conventional financial institution. For example, client devices may communicate with the DLT application 60 using the BIC code 64 and the client account number mapping to DLT wallets 61, 62, or 63. This would typically apply in the case of institutional clients which may maintain accounts at multiple financial institutions and may use the BIC code and account number to route their instructions to the appropriate destination. The DLT application 60 has further advantages as described above.

In some cases, the operators of the client devices 70 and 80 might be the same as the owners of the transferor/transferee accounts 10 or 13 (e.g., if “Client I” owns the conventional account 10, and moves assets from the conventional account 10 to the securities account 41 for credit to its wallet on the DLT application 60, then it also plays the role of transferor).

The sets of financial applications 40 and 50 may communicate with the DLT application 60 via sets of instructions 46 and 47 using conventional messaging protocols (e.g., ISO15022 messages sent over a SWIFT network or other standard interfaces (e.g., API’s) made available by set of financial applications 40 to its clients). The sets of instructions 46, 47, may be asset transfer instruction messages, status messages, credit or debit confirmations, intraday or end of data balance updates, etc.

The sets of financial applications 40 and 50 may also communicate with the DLT application 60 via custom messaging methods via sets of instructions 48 and 49. The sets of instructions 48 and 49 may have been developed or configured to integrate the DLT application 60 with the set of financial applications 40. For example, the sets of instructions 48 and 49, may include messages to screen for sanctions, retrieve security data attributes, or to reconcile aggregate of balances on DLT wallets and on conventional accounts, etc. The level and functionality of the integration of custom messaging between the DLT application 60 and different financial applications may vary by financial institution (e.g., the financial institution running the set of financial applications 40 may have established a custom messaging protocol with the DLT application 60 but the financial institutions running the set of financial applications 50 may only rely on a conventional messaging protocol, and would thus not use custom messaging except for integration with a smaller set of internal applications). In another embodiment, a financial institution may send sets of instructions 46 or 47, referred to earlier, via custom messaging. As described herein, the sets of instructions 46, 47, 48, and 49 that are exchanged between the DLT application 60 and the set of financial applications 40 are exchanged only with the appropriate or applicable application (e.g., internal application or sub-application) or interface of the set of financial applications 40 and/or the DLT Application 60.

In initiating a transaction that is facilitated by the DLT application 60, a user may access one of two categories of user interfaces (e.g., a conventional user interface 71 or a user interface 72 for a cryptographic wallet) at a client device 70. Similarly, client device 80 could use a conventional user interface 81 or a user interface 82 for a cryptographic wallet. For example, a user may access a financial institution-provided user interface 71 that the client device 70 may present in response to executing a client application that was provisioned to the client device 70 or via a browser. The user interface 71 may be provided by the financial institution at which the client maintains its securities or cash accounts or sourced by the client otherwise (e.g., developed internally by the group entity (e.g., a business or organization) that owns or otherwise operates the client device or sourced from other providers) for viewing account balances or activity, initiating transaction instructions, receiving end-of-period or intra-period (e.g., intra-day reports), monitoring status of earlier requests, carrying out other account-related operations, etc. In some cases, there may be multiple financial-institution provided (or client-sourced) interfaces 71 for accessing different assets or for carrying out different operations related to the same asset. For instance, one interface may be configured to present cash balances, another interface may be configured to present securities balances, etc. Alternatively, one interface may be used to initiate transactions, and another may be used to retrieve and reconcile end of day balances. Such interfaces may allow a user at the client device 70 to configure standard routing details for messages to send to their respective financial institutions (e.g., using BIC code and account number for their cash or securities accounts), and then exchange messages with their financial institution using conventional messaging protocols (including but not limited to ISO15022, ISO20022 messages sent via Swift, or via API’s). In one embodiment, the user interfaces route these messages to the DLT application 60 using the client account number and the BIC code of the DLT application 60, and validates received messages from the DLT application 60 using the same BIC code.

When using interfaces 71 or 81, the client devices 70 or 80 may communicate with the DLT application 60 via sets of instructions 73, 74, 83, and 84. The sets of instructions 74 and 84 are instructions sent by the client devices 70 and 80, respectively, and may be instructions to initiate standard asset transfers (i.e., asset transfers types available in conventional networks e.g., cash transfers initiated using MT202). The sets of instructions 73, 74, 83, and 84 may represent groups of instructions or messages that are sent via a conventional protocol between interfaces 71 or 81 and the DLT application 60. Such sets of instructions may include any number of exchanged instructions. The standard asset transfer requests may also be used to initiate detokenization (i.e., destroy a token and transfer the destroyed token’s underlying asset to a conventional account that is unlinked from the DLT application (e.g., transferor/transferee accounts 10 or 13)). In operation, the DLT application 60 may be authorized by the different account owners to send and receive conventional sets of instructions to various financial institutions on the account owners’ behalf. In cases in which a user does not wish to provide the DLT application 60 with authorization to send such sets of instructions and the DLT application 60 has settings that indicate it is not permitted to transmit sets of instructions for the user, the DLT application 60 can still be configured to receive the sets of instructions 73 and 83 on the user’s behalf.

In some cases, the sets of instructions 73 and 83 may represent the sets of instructions received by clients as described above, and may include messages with status updates and EOD messages for various transactions. Advantageously, the sets of instructions 73 and 83 may even be related to transactions that are initiated via one of the application interfaces 72 or 82 (i.e. not just to transactions initiated via the sets of instructions 74 and 84). Accordingly, the DLT application 60 may allow clients the flexibility to specify preferences as to which sets of instructions they receive, and via which channels. A benefit of this feature is that while some advanced users may initiate non-standard or standard transfers (via DLT Application interface 72, using the sets of instructions 76), settlement teams can receive confirmations via conventional channels (e.g., via the sets of instructions 73).

For example, if an entity is an organization, it is not uncommon to have different employees that have different responsibilities in the transaction life cycle, including transaction booking (booking transactions /accepting transactions initiated by counterparty) and reconciliation (based on transaction confirmations and/or EOD or other balance or transaction statements). Thus, some employees responsible for transaction booking may continue using the conventional user interfaces 71 or 81 to initiate standard transactions without changing transaction protocols, some may adopt new interfaces (e.g., the application interfaces 72 or 82) to initiate standard or non-standard transactions (for the avoidance of doubt, use of application interfaces 72 and 82 could be referred to as using a digital wallet that is stored in application 60 or in the client devices 70 or 80), but the employees responsible for reconciliation could still choose to use existing protocols for their reconciliations (messages received in the sets of instructions 73 or 83). Even in the case of non-standard transactions (e.g., transfer out Security A and receive Security B at the same time), the user may receive standard messages on transaction status for each individual asset during the transaction lifecycle (e.g., a credit message for Security B, and a debit message for Security A).

The client devices 70 or 80 may communicate with the DLT application 60 from application interface(s) 72 or 82. The application interface(s) 72 and 82 may be one or more custom interface(s) provided by the DLT application 60 for clients to view wallet balances or activity, initiate transactions, receive end-of-period or intra-period (e.g., intra-day reports), monitor status of earlier requests, and carry out other account-related operations. The DLT application 60 may provide multiple such interfaces, including but not limited to Graphical User Interfaces (GUI) and API’s (also, notifications from the DLT application 60 to client devices 70 and 80 could also be sent via pre-specified channels, e.g., email). The application interface(s) 72 and 82 may also transmit sets of instructions 76 and 86 to the DLT application 60 to initiate and cryptographically sign instructions for standard transfers (which would include outgoing-transfer instructions for detokenization and incoming-transfer instructions for tokenization in addition to outgoing and incoming transfer instructions for assets to other wallets) or non-standard asset transfers (defined further) as well as accept “allegements” as is described in detail below. Non-standard asset transfers are those not available via conventional networks, (e.g., transfer out Security A and receive Security B at the same time; or transfer out a specified asset if a defined condition is satisfied). As described herein, allegements may mean that instead of having to enter all details of a transaction which would be matched with details entered by the other counterparty/counterparties, the party is shown details entered by others (via the application interface 72). The party can then choose to accept, modify or reject the transaction.

In the same embodiment, the application user interfaces 72 and 82 may allow the client devices 70 and 80 to receive messages in the sets of instructions 75 and 85 from the DLT application 60. Examples of such messages include, but are not limited to, status messages for requests initiated via the sets of instructions 76 or 86 and EOD messages, as well as copies of some or all messages which could potentially be sent by the DLT application 60 in the sets of instructions 73 or 83 (e.g., if an EOD MT940 is sent in the sets of instructions 73, the same may be visible via the application interface 72 as well). As described herein, the sets of instructions 73, 74, 75, 76, 83, 84, 85, and 86 that are exchanged between the DLT application 60 and the interfaces 71, 72, 81, and 82 are exchanged only with the appropriate or applicable application (e.g., internal application or sub-application) or interface of the DLT Application 60.

Optionally, the application user interfaces 72 and 82 may be used to send outgoing-transfer instructions (to trigger tokenization) to the transferor/transferee accounts 10 or 13 or to instruct incoming-transfer instructions (in the case of detokenization) to the transferor/transferee accounts 10 or 13 if the client of the DLT application 60 is the same as the transferor or transferee, or is otherwise authorized to instruct on behalf of the transferor or transferee.

The DLT application 60 may communicate and update the DLT network 90 as users perform transactions between each other. The DLT network 90 may be a network of validating nodes (e.g., computing devices) and a distributed ledger that maintains a record of the state and balances of wallets (e.g., the wallets 61-63 that are stored by the DLT application 60). The DLT application 60 may communicate with the DLT network 90 via sets of instructions 91 and 92. For example, the DLT application 60 may update DLT network 90 by transmitting messages in the sets of instructions 91 to the DLT network 90 with updates on the state and balance of the wallets 61-63. The DLT network 90 may transmit the sets of instructions 92 to the DLT application 60 to provide the DLT application 60 with the necessary data to complete an operation, process or instruction, and/or to provide the DLT application 60 with the necessary data from the ledger for the DLT application 60 to present to a user (e.g., to present the current holdings in the wallets 61-63 to their respective owners).

In some cases, the DLT application 60 may maintain wallets to access other DLT networks outside of the DLT network 90. For example, the DLT application 60 may maintain wallets to access DLT network 93, which may be a DLT network outside the DLT application 60’s trust network/zone. The DLT network 90 may connect to the DLT network 93 to interact with the ledgers for other applications (and the clients connecting to these applications) outside the trust zone. This is to make sure that the applications (e.g., the applications that communicate and/or manage each distributed ledger) and messages and tokens of each of the applications can flow amongst each other (e.g., among the connected application) and can interoperate.

For instance, the DLT network 90 may exchange sets of instructions 94, 95, with DLT network 93 or with nodes of the same DLT network 90 but outside of the DLT application 60’s trust network. Accordingly, the sets of instructions 94, 95, and the underlying mechanisms act as an inter-DLT bridge that enable interoperability.

As described herein, the system 100 may include components and applications that conventional systems use to process transactions as well as non-conventional components that are described herein. For example, conventional systems may include transferor/transferee accounts 10-13, FMI 30, sets of instructions 31 and 32, and sets of financial applications 40 and 50. The components that enable the systems and methods described herein and are not present in conventional systems, however, include the DLT application 60, the wallets 61-64, the BIC code 64, the application interfaces 72 and 82 (including channels or protocol that facilitate transfer of the sets of instruction 75, 76, 85, and 86), and integration of the DLT application 60 with the other applications 45 (via the sets of instructions 47-49). Accounts 41-44 may be reconfigured to operate with DLT application 60, but may otherwise be standard accounts. For example, the accounts 41-44 may be set up to accept incoming instructions from the BIC for the DLT Application 60, send outgoing instructions to the BIC for the DLT application 60, restrict (e.g., disallow) outgoing payment instructions originating from any other applications in the set of financial applications 40, etc.

FIG. 2 illustrates a flowchart depicting operational steps for tokenizing a transaction, according to an embodiment. The method 200 describes how a DLT-enabled application (DLT application) can facilitate a transaction with a conventional account and keep a record of the transaction on a distributed ledger. The DLT application may be the DLT application 60, shown and described with reference to FIG. 1. The method 200 is described below with reference to components (e.g., the FMI 30, the set of financial applications 40, and the DLT application 60) of the system 100 as the system 100 is described with reference to FIG. 1 above. However, it should be noted that the method 200 may be performed by any number of components. Furthermore, other configurations of the method 200 may comprise additional or alternative steps, or may omit one or more steps altogether.

The DLT application may store a plurality of digital wallets connected to a distributed ledger and the second application may store a plurality of conventional accounts linked to the plurality of digital wallets. Additionally, the DLT application may store a mapping of the digital wallets connected to the distributed ledger to the plurality of conventional accounts.

At step 202, the FMI 30 may receive a transaction request from a first client device. The transaction request may be a request to deliver an asset (e.g., a cash or securities asset) from a source account at a financial institution to a destination account on a distributed ledger. The transaction request may include identifications of the source account, a recipient account (e.g., an account hosted by the set of financial applications 40), and the ultimate destination account. The transaction request would be sent using standard asset-specific messages communicated over conventional messages channels (e.g., sets of instructions 31 or 32). Examples of asset-specific messages would include MT542 for securities and MT202 for cash. Such message formats usually allow specification of the source and recipient accounts, and include additional fields which could be used to specify the ultimate beneficiary, i.e. the ultimate destination account. The FMI 30 may receive the transaction request from a server of the financial institution that hosts the transferring account. In some cases, the FMI 30 may receive the transaction from the server after the server carries out a series of validations and checks according to its own internal policies (e.g., balance checks and sanctions screening) and then routes the request to the FMI 30 using conventional messaging.

Optionally, at step 204, the DLT application 60 may receive a “receive instruction” or a “credit pre-advice” from a second client device using conventional messaging (e.g., the sets of instructions 74) or custom messaging (e.g., the sets of instructions 76) depending on the configuration of the established communication channel. The DLT application 60 may receive the instruction or the credit pre-advice based on the type of asset that is being transferred. The receive instruction may include identifiers of the source account and the destination account (which would correspond to the ultimate destination account in the previous step. This corresponds to an individual wallet) and indicate the asset being transferred from the source account to the destination account. In some cases, the receive instruction may also include a BIC code of the DLT application 60 that enables the second client device to communicate with the DLT application 60 using a SWIFT or another conventional communication protocol.

Optionally, at step 206, the DLT application 60 may carry out any necessary validation and then create and send a new “receive instruction” to the set of financial applications 40. The “receive instruction” that the DLT application 60 creates may be distinct from the original “receive instruction” received from the client; that instruction was sent by the authorized client to DLT application. The new receive instruction may be sent by the DLT application 60, which is authorized to send instructions to one or more accounts maintained in the set of financial applications 40. This new receive instruction may set the source account the same as in the original receive instruction, but would set the destination account as the account in the set of financial applications 40 which maps to the wallet for the asset in question, and may also specify the ultimate destination account, which would be the destination account in the original receive request. The DLT application 60 may send the receive instruction to the set of financial applications 40 using conventional messaging or custom message depending on the configuration of the established communication channel between the DLT application 60 and the set of financial applications 40 (e.g., via the sets of instructions 47 or 49).

Optionally, at step 208, the set of financial applications 40 may validate the “receive instruction” that it receives from the DLT application 60. The set of financial applications 40 may do so using internal policies with various rules indicating how to validate such receive instructions. Upon validation, the set of financial applications 40 may route the receive instruction to the FMI 30 using a conventional messaging protocol.

Optionally, at step 210, the FMI 30 may match the receive instruction with the transaction request from the first client device. For example, the FMI 30 may compare the attributes (e.g., the different account identifiers and/or the identification of the asset) of the two requests and determine whether the attributes match. If the FMI 30 determines the assets do not match, the FMI 30 may generate an error message and stop the transaction from occurring. Otherwise, if the FMI 30 determines the instructions match, at step 212, the FMI 30 may settle the transaction by crediting the asset to the recipient account and debiting the asset from the source account. At step 214, the FMI 30 may transmit a debit confirmation of the transaction to the first computing device (e.g., to the source account that the first computing device is accessing) to indicate the transaction was successful. The FMI may also transmit a message to the set of financial applications 40 indicating the credit to the recipient account. The FMI may transmit such messages using a conventional messaging protocol.

At step 216, the set of financial applications 40 may transmit a confirmation of the credit to the DLT application 60. The set of financial applications 40 may transmit the confirmation using conventional messaging (e.g., sets of instructions 46) or custom messaging (e.g., sets of instructions 48). The set of financial applications 40 may create and transmit a new credit confirmation in a message including an identifier of the destination account of the transaction as the ultimate beneficiary of the transaction. At step 218, the DLT application 60 may issue a token for the transaction (e.g., the DLT application 60 may credit the asset of the transaction into the destination account) by exchanging messages to and from the distributed ledger for which the DLT application 60 maintains digital wallets indicating the transaction and the credit into the destination account.

At step 220, the DLT application 60 may transmit a credit confirmation in addition to other messages (e.g., transaction status messages, intraday statement, end of day statements, etc.) to the destination account (e.g., to the second client device accessing the destination account). However, if the settlement fails (e.g., if the receive instructions did not match the transaction request), the DLT application 60 may transmit a message to the destination account to indicate the transaction could not be processed. Additionally, if the DLT application 60 receives a cancellation message for the destination account before the transaction has finished processing, the DLT application 60 may transmit a message to the set of financial applications 40 to cancel and stop the transaction from occurring.

In some cases, the recipient account in the set of financial applications 40 may not be an omnibus account. In such cases, the designation of the ultimate destination account may not be needed at any stage and the recipient account may be the ultimate beneficiary account of the transaction.

In some cases, if the user owns both the source account and the destination account, the user may request the DLT application to initiate the ‘deliver instruction’ which is usually received from a first client device at step 202. The user may only do so, in some cases, if the DLT application is authorized to do so (e.g., has the appropriate account permissions).

Further, in some cases, depending on the asset in question, a transfer over a conventional settlement network may not need matching instructions (for example, for transferring USD, it may suffice to just have a delivery instruction). In such cases, steps 204, 206, 208 and/or 210 may be skipped.

These are just illustrative flows for tokenization. The process for tokenization (and detokenization) may vary based on the underlying financial instrument being tokenized. The above process applies for securities and cash. The DLT application 60 may also be configured for other instruments (e.g., letter of credit). In such cases, the process would change as other asset classes may be get instantiated using different methods. For instance, digital native assets may never have a conventional format and a trade receivable token might get created when party A accepts a liability to pay party B in the future. As described herein, digital native assets may be crypto assets, represented on a DLT (with an assigned ownership), that do not have an equivalent asset representation in conventional financial infrastructure; these digital native assets may or may not represent a physical asset.

FIG. 3 illustrates a flowchart of a process for detokenization, according to an embodiment. The method 300 describes how a DLT enabled application can facilitate a transaction with a conventional account and keep a record of the transaction on a distributed ledger. The DLT application may be the DLT application 60, shown and described with reference to FIG. 1. The method 300 is described below with reference to components (e.g., the FMI 30, the set of financial applications 40, and the DLT application 60) of the system 100 as the system 100 is described with reference to FIG. 1 above. However, it should be noted that the method 300 may be performed by any number of components. Furthermore, other configurations of the method 300 may comprise additional or alternative steps, or may omit one or more steps altogether.

At step 302, the DLT application 60 may receive a deliver instruction from a first client device. The deliver instruction may be an instruction to transfer an asset from a source account hosted by the DLT application (e.g., a digital wallet) into a destination account stored in a conventional system. The deliver instruction may include identifiers of the source account and the destination account. For example, the deliver instruction may be to transfer an asset to a particular transferee account (e.g., transferor/transferee account 10 or 13) from a given wallet (e.g., one of wallets 61-63). In some cases, the deliver instruction may include a BIC code for the DLT application 60 to enable the deliver instruction to be routed to the DLT application 60 using SWIFT messaging (e.g., sets of instructions 84). At step 304, the DLT application 60 may validate the transaction request to verify that it is a valid request.

At step 306, the DLT application 60 may freeze the balance of the source account (e.g., the token). By doing so, the DLT application 60 may make the balance unavailable for any transfers. The DLT application 60 may then create a new delivery instruction. This new delivery instruction may indicate the destination account (which would be the same as the destination account in the original request received from the client), but the source account would now be indicated as the conventional account in the set of financial applications 40 to which the balance in the wallet is mapped for the particular asset in question. This new delivery instruction may include details of the ultimate source account (the wallet Id). The DLT application 60 may then route the transaction request to the set of financial applications 40, wherein the transaction request is routed to the set of financial applications 40. The DLT application 60 may transmit the transaction request to the set of financial applications 40 using conventional or custom messaging (e.g., via the sets of instructions 47 or 49).

Optionally, at step 308, the set of financial applications 40 may validate the request and route the request to the FMI 30. The set of financial applications 40 may validate the request using conventional request validation policies. The set of financial applications 40 may then route the request to the FMI 30. The set of financial applications 40 may do so using conventional messaging protocols (e.g., via the sets of instructions 32).

Optionally, at step 310, the FMI 30 may receive a receive instruction from a second client device. The FMI 30 may receive the receive instruction from the second client device through the financial institution that maintains the destination account that was identified in the transaction request from the first client device. The FMI 30 may receive the receive instruction after the financial institution validates the receive instruction and routes the receive instruction to the FMI 30 via a conventional message protocol). The receive instruction may include identifications of the destination account, the source account, and the ultimate source account. The receive instruction may include a reference to the asset being transferred to the destination account. The FMI 30 may receive the receive instruction via the instruction 21.

Optionally, at step 312, the FMI 30 may match the receive instruction with the transaction request from the first client device. The FMI may match the receive instruction with the transaction request in a similar manner to the manner described above (e.g., compare the attributes (e.g., the different account identifiers and/or the identification of the asset) of the two requests and determine whether the attributes match). If the FMI 30 determines the assets do not match, the FMI 30 may generate an error message and stop the transaction from occurring. Otherwise, if the FMI 30 determines the assets match, at step 314, the FMI 30 may settle the transaction by crediting the asset to the destination account and debiting the asset from the recipient account stored on the set of financial applications 40. At step 316, the FMI may transmit (via the sets of instructions 22) a credit confirmation to the destination account being accessed by the second computing device and transmit (via the sets of instructions 31) a confirmation message for the debit to the set of financial applications 40.

At step 318, the set of financial applications 40 may receive the debit confirmation (i.e., the debit from the conventional account in the set of financial applications 40 which maps to the wallet from which the asset is being transferred) from the FMI 30 and then create and transmit to the DLT application 60 a new confirmation of the debit from the wallet. The set of financial applications 40 may transmit the confirmation to the DLT application 60 using a conventional communication protocol or a custom messaging protocol (e.g., via the sets of instructions 46 or 48). At step 320, the DLT application 60 may receive the confirmation and burn the previously frozen token in the source account (e.g., debit the asset of the transaction from the source account). At step 322, the DLT application 60 may transmit a debit confirmation in addition to other transaction details (e.g., transaction status messages, intraday statement, end of day statements, etc.) to the first computing device (e.g., to the source account that the first computing device is accessing). The DLT application 60 may do so using conventional messaging protocols (e.g., the sets of instructions 84 and 86) or custom messaging protocols (e.g., via the sets of instructions 83 and 85).

In some cases, if the same entity owns both the source account (wallet on 60) and the destination account (e.g., the transferor/transferee account 10 or 13), the user may request the DLT application 60 to initiate the ‘receive instruction’, which is usually received from a second client device at step 310. The user may only do so, in some cases, if the DLT application 60 is authorized to do so (e.g., has the appropriate account permissions).

Further, in some cases, depending on the asset in question, a transfer over a conventional settlement network may not need matching instructions (for example, for transferring USD, it may suffice to just have a delivery instruction). In such cases, step 312 and 314 may be skipped.

In some cases, the recipient account in the set of financial applications 40 is not an omnibus account. In such cases, the designation of the ultimate source account may not be needed at any stage.

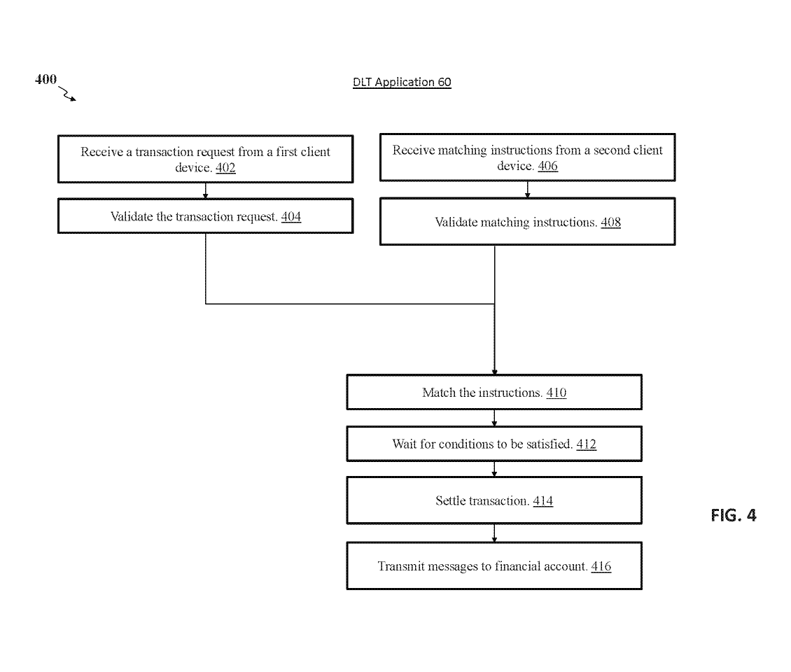

FIG. 4 illustrates a flowchart of a process for token transfer, according to an embodiment. The method 400 describes how a DLT enabled application can facilitate a token transfer between two wallets of the distributed ledger to which the DLT enabled application is linked. The DLT application may be the DLT application 60, shown and described with reference to FIG. 1. The method 400 is described below with reference to components (e.g., DLT application 60) of the system 100 as the system 100 is described with reference to FIG. 1 above. However, it should be noted that the method 400 may be performed by any number of components. Furthermore, other configurations of the method 400 may comprise additional or alternative steps, or may omit one or more steps altogether.

At step 402, the DLT application 60 may receive a transaction request identifying one or more tokens, and involving one or more counterparty accounts (in the simplest case, this would be a request to transfer a token from a source account to a destination account). Each account may be a digital wallet on the distributed ledger associated with the DLT application 60. In some embodiments, the accounts may include accounts on other distributed ledgers. The DLT application 60 may receive the transaction request from a first client device that is accessing the account through a user interface (e.g., financial institution-provided/client-sourced interface 71 or a DLT application user interface 72). The user may use the user interface 71 and the sets of instructions 74 for standard transfers (defined above), or the application user interface 72 and via the sets of instructions 76 for standard or non-standard asset transfers.

At step 404, the DLT application 60 may validate the transaction request, carrying out any required checks and/or rules in doing so. Optionally, at step 406, the DLT application 60 may receive a matching instruction from a second client device. A user accessing the second client device may send the instruction using the conventional user interface (e.g., the sets of instructions 84) for matching standard transfer requests. Alternatively, the user may send the instruction using the DLT application user interface (e.g., via the sets of instructions 86) for matching standard or non-standard asset transfer requests, or accepting “allegements” of transactions initiated by the first client device. Advantageously, by implementing the systems and methods described herein, even if the first client sends a standard instruction via conventional interface, the second client could use a conventional interface or a custom interface. The second client device may not be required to provide a matching instruction if the DLT application 60 has been configured to not require such matching instructions if certain conditions are met. These conditions may be based on attributes like asset type, transaction type, transaction amount, etc. (e.g., it may not require matching instructions for a one-legged transfer of certain assets below a particular amount). Additionally, the second client device may not be required to provide matching instructions if the second client device has previously specified a preference to accept incoming transfers if certain conditions are met. These conditions may be based on attributes such as the asset type, transaction type, counterparty details, transaction time, transaction amount, etc. (e.g., a US party may accept transactions under $1000 from Asian counterparties during Asian business hours, which are outside US business hours). At step 408, the DLT application 60 may validate the matching instructions.

In some cases, DLT application 60 may be configured to require matching transactions at an asset and transaction type level. This may allow the DLT application 60 to standardize protocol for transfers for different assets (e.g., even for cash token transfers, it could mandate the need for a matching instruction to be provided).

In some cases, the transaction may have more than two legs (e.g., entity A may transfer 100 units of asset 1 to entity B, and entity B may transfer 50 units of asset 2 to entity C. In such cases, the parties to each portion of the transaction may similarly provide instructions to the DLT application 60 for validation and matching.

At step 410, the DLT application 60 may match the instructions from each of the entities (e.g., the DLT application 60 may match the instructions of all of the transaction requests, receive instructions, and/or deliver instructions). In response to the instructions matching, at step 412, the DLT application 60 may wait on any conditions that need to be satisfied before the transaction can be executed. In doing so, the DLT application 60 may apply any applicable priority rules. At step 414, the DLT application 60 may settle the transaction (e.g., single or multiple-legged transaction) by transferring the tokens of the transactions between the wallets identified in the requests and maintained by the DLT application 60. The DLT application 60 may update the distributed ledger to indicate the transaction went through.

In case any transfers involve assets for which the distributed ledger does not act as sub-ledger (e.g., there is a client-specific account held in conventional infrastructure), the DLT application 60 may reflect the transaction in client-specific accounts by passing on appropriate messages to one of set of financial applications 40 or 50. The DLT application 60 may do so using custom messaging protocols (e.g., sets of instructions 49).

At step 416, the DLT application 60 may transmit messages to the client devices that initiated and/or took part in the transaction. For example, the DLT application 60 may send transaction status messages, settlement confirmations, intraday and end of day statements to the client devices. The DLT application 60 may do so using conventional communication protocols (e.g., in sets of instructions 73 or in sets of instructions 83) and /or custom protocols (e.g., using the sets of instructions 75 or the sets of instructions 85).

In one non-limiting example, in the case of non-standard transactions involving more than one asset transfer, the DLT application 60 may have the capability to send conventional messages for individual legs of the trade, with a common transaction reference. Thus, if the DLT application 60 executes a trade where entity I pays entity J EUR 1000, entity J pays entity I USD 600 and entity J pays entity K USD 580 at the same time (which is a non-standard instruction), the DLT application 60 can send debit and credit confirmations for the three individual legs. This ensures that reconciliation systems used by clients can process transfers arising from non-standard transactions as well.

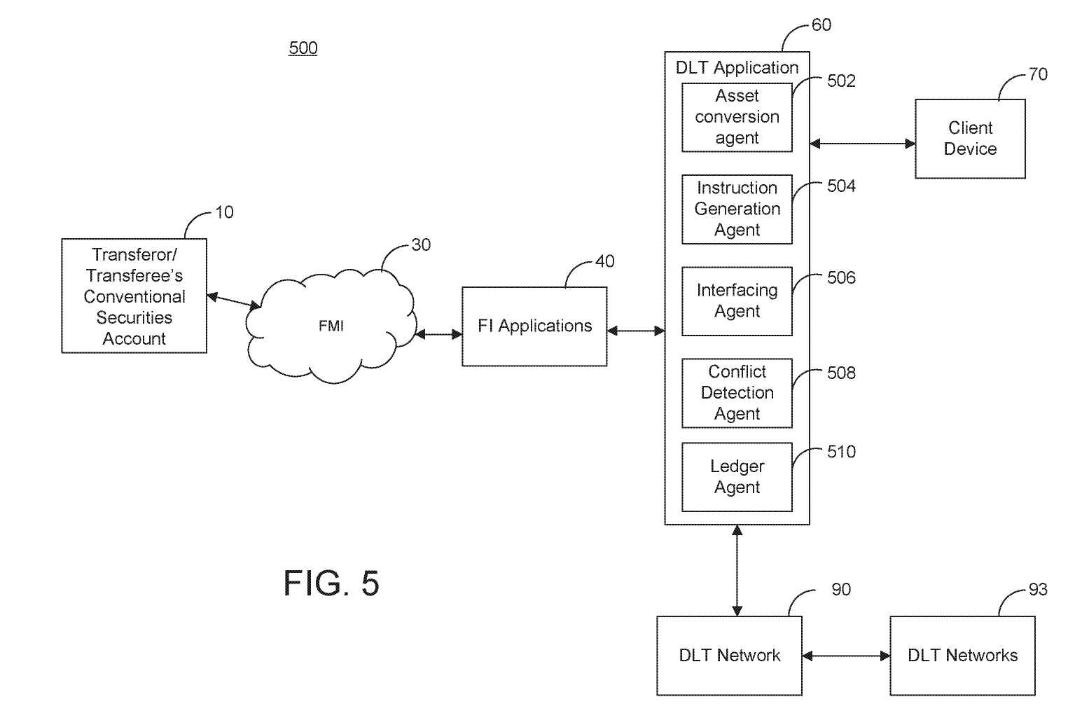

In some cases, the DLT application 60 can perform asset transfers using an agentic system. For example, referring now to FIG. 5, illustrated is a block diagram of a system 500 for seamlessly processing transactions using distributed ledger technology with an agentic architecture, in accordance with one or more implementations. The system 500 can include the transferor/transferee's conventional securities account 10, the financial market infrastructure (FMI) 30, the set of financial applications (FI Applications) 40, the DLT application 60, the client device 70, the external service/device 90, and the one or more distributed ledger technology networks 93. The system 500 can be the same as or similar to the system 100, shown and described with reference to FIG. 1. As shown in FIG. 5, the DLT application 60 can include, store, execute, or operate an agentic architecture to facilitate transaction processing between disparate computing architectures through varying connections and communication protocols.

As described herein, the agentic system of the DLT application 60 can include a Reasoning Engine. The reasoning engine can be configured to interpret task intent, constraints, and system state. The reasoning engine can evaluate alternative execution paths across heterogeneous infrastructures. The reasoning engine can generate structured action plans aligned with policy, cost, latency, and risk constraints. As described herein, the reasoning engine can be trained or condition on multi-ledger state, legacy system signals, and transaction dependencies. The reasoning engine can be configured or trained to perform probabilistic decisioning combined with deterministic rules for financial-grade reliability.

The agentic system of the DLT application 60 can include an orchestration engine. The orchestration engine can be configured to coordinate multiple agents and tools; enforce execution ordering, dependencies, and atomicity; and manage concurrency across legacy systems and distributed ledgers. In some implementations, the orchestration engine can perform cross-system transaction orchestration (e.g., facilitate transactions between legacy and DLT-based systems). The orchestration engine can do so using contingent and concurrent execution logic, in some cases implementing rollback, compensation, and reconciliation workflows to address any conflicts or errors that occur during orchestration.

The agentic system of the DLT application 60 can include a tool interface. The tool interface can include or interact with APIs, functions, external systems, etc. The tool interface can include one or more agents that are configured to interact with legacy enterprise systems (e.g., core banking, ERP, custodians, databases); distributed ledger nodes and smart contracts; and/or external APIs, microservices, and messaging systems. The tool interface can include standardized adapters and protocol bridges. In some cases, the tool interface can include a normalized abstraction layer for heterogeneous tools. The tool interface can include capability metadata of different tools to use to perform specific tasks of a workflow, as well as dynamic tool discovery that is configured to detect or discover new available tools.

The agentic system of the DLT application 60 can include its own memory (e.g., short-term memory, long-term memory, episodic memory, etc.), which may be allocated to the DLT application 60 in memory. The memory can include a short-term memory, which can store active task context and intermediate states. The memory can include a long-term memory, which can store historical performance data, policies, and system knowledge. The memory can include episodic memory, which can store data regarding previously completed workflows, exceptions, and outcomes. The memory can include transaction-aware memory, which can be indexed by asset, ledger, and system state. The memory can include cross-ledger historical traceability for audit and compliance.

The agentic system of the DLT application 60 can include a context retriever, which can use retrieval-augmented generation (RAG) and search capabilities. The context retriever can enable agents to establish a “logical ledger abstraction,” such as by gathering context from a variety of sources. These sources include structured data such as ledgers, databases, and transaction logs, as well as unstructured sources such as documents, policies, and contracts, and system state snapshots. The context retriever can provide agents with a unified logical ledger view that spans multiple infrastructures, allowing for semantic mapping between legacy records and distributed ledger technology (DLT) states. As a result, agents can seamlessly interpret and reconcile data across disparate systems, ensuring consistent and comprehensive transaction processing.

The agentic system of the DLT application 60 can implement guardrails to ensure the agents of the agentic system operate within clearly defined policy constraints. The guardrails can include constraints encompass regulatory requirements, risk thresholds, governance rules, and operational limitations such as latency, cost, and reliability. The agents can use policy-driven transaction routing, make decisions that are aware of compliance requirements, and enforce atomicity, segregation of duties, and access control.

During operation, the agentic system of the DLT application 60 can maintain a continuous representation of transaction state, system state across infrastructures, and dependency graphs between sub-tasks. While doing so, the agentic system can maintain cross-system state synchronization, detect divergence between legacy and DLT states, and include state-based triggers for agent actions.

Additionally, the agentic system of the DLT application 60 can implement a feedback protocol. In doing so, the agentic can continuously improve based on or for execution outcomes, system performance metrics, policy compliance, error and anomaly patterns. For example, the agentic system can implement transaction-level scoring (e.g., success, risk, deviation), feedback loops for orchestration optimization, and self-tuning execution strategies across infrastructures.

As described herein, agents within the agentic system of the DLT application 60 can have different capabilities. For example, the agents can decompose high-level objectives into sub-tasks mapped to legacy systems, DLT operations, and external tools and dependency graphs reflecting transaction constraints. In doing so, the agents can decompose workflows into cross-ledger and cross-system transaction steps. The agents can generate execution plans based on system state, asset types, policy constraints, and/or risk and cost trade-offs. The agents can perform selection between legacy, DLT, or hybrid execution paths and dynamic plan adaptation based on real-time system signals. The agents can select and invoke tools based on capability metadata, system availability, and execution constraints. In doing so, the agents can implement routing logic across heterogeneous financial infrastructures, and fallback strategies across multiple ledgers and systems.

The agents of the agentic system of the DLT application 60 can ground decisions using unified ledger representations, historical transaction data, and regulatory and contractual context. In doing so, the agents can ground the decisions to ensure cross-ledger consistency and using reconciliation data. In some cases, the agents can operate in closed-loop cycles including planning execution steps, performing actions across systems, observing outcomes and state changes, and refining plans dynamically. The agents can implement iterative orchestration of contingent and concurrent transactions.

In some cases, the agents of the agentic system of the DLT application 60 can implement state update and memory read/write operation. The agents can do so by continuously updating transaction state graphs, system state representations, episodic memory of execution outcomes. In operation, the agents can use persistent cross-system state models for auditability and traceability. The agents can validate and self-check operations. The agents can validate consistency between legacy and DLT states, policy compliance, and execution correctness. The agents can use atomicity verification across infrastructures and detect partial failures and divergence.

The agents of the agentic system of the DLT application 60 can produce output synthesis. In doing so, the agents can generate final transaction outcomes, explanations and audit trails, and system-level summaries. The agents can generate unified transaction records spanning legacy and distributed ledgers. The agents can enable multiple functions. For example, the agents can enable multi-step execution and extension of the multi-asset transaction model. The agents can execute complex workflows including multiple systems, multiple ledgers, multiple asset types.

The agents of the agentic system of the DLT application 60 can implement autonomous workflows. In doing so, the agents can autonomously initiate, coordinate, and complete transactions, handle exceptions and compensations, and optimize execution paths.

The agents of the agentic system of the DLT application 60 can implement environment interaction and reframing of financial infrastructure as an “agent environment.” In doing so, agents can interact with enterprise infrastructure, distributed networks, regulatory and governance frameworks.

The agents of the agentic system of the DLT application 60 can use cross-tool coordination and the agentic version of interoperability middleware. In doing so, the agents can coordinate application programming interfaces (APIs), smart contracts, databases, messaging systems, legacy workflows and DLT processes.

The agents of the agentic system of the DLT application 60 can implement adaptive behavior and extend the dynamic orchestration into adaptive intelligence. In doing so, agents can adapt to system failures, network congestion, regulatory changes, and asset volatility.

The agents of the agentic system of the DLT application 60 can implement goal-driven optimization and formalization of “intelligent routing.” The agents optimize for latency, cost, risk, compliance, and transaction success probability.

The agents of the agentic system of the DLT application 60 can implement long-horizon tasks maps to multi-phase financial transactions. The agents can manage multi-stage settlement cycles, lifecycle of assets, and long-running workflows. The agents of the agentic system can learn from feedback and transforms static orchestration into evolving intelligence. The agents can learn from historical execution outcomes, anomalies and failures, and policy violations.

The agents that the DLT application 60 executes or triggers execution of that are described separately may operate as individual agents as described or the functions described as being performed by multiple agents or may be performed may be performed by a single agent. Thus, the DLT application 60 can be configured to operate or execute any number of agents. For example, one agent can be configured to perform the task of two or more agents that are described herein.

The DLT application 60 can execute or otherwise trigger execution of the different agents. For example, the DLT application 60 can trigger execution of the different agents by executing the agents itself, calling (e.g., via an API call) the agents to be executing at or by a different computing system, or otherwise cause another computer program to execute the agents. In this way, the DLT application 60 can execute or cause execution of different workflows through the agents.

For example, the DLT application 60 can include an asset conversion agent 502. The asset conversion agent 502 can be a software component (e.g., a set of instructions) executed by one or more processors executing or processing the DLT application 60 to determine whether asset conversion operations is required for completing a transaction between a conventional computing system and a distributed ledger. For example, the asset conversion agent 502 can be implemented as a set of processor-executable instructions stored in memory that, when executed, perform analysis of asset types, account types, and transaction parameters to identify conversion requirements. The asset conversion agent 502 can execute logic to determine whether any asset conversion is required to complete the transfer between the banking computing system and the distributed ledger. In some cases, the asset conversion agent 502 can analyze attributes of a receive instruction from the client device 70 to identify discrepancies between asset formats, account structures, or protocols used in conventional banking computing systems versus distributed ledger systems. The asset conversion agent 502 may apply a set of rules or execute a decision tree to evaluate transaction parameters against predefined criteria for asset conversion requirements. For instance, the asset conversion agent 502 can compare an identifier of a DLT-based client account with mapped conventional account identifiers to determine whether tokenization, detokenization, or account mapping operations are necessary before settlement.

The asset conversion agent 502 can execute one or more large language models to analyze transaction instructions and determine asset conversion requirements. In some cases, the asset conversion agent 502 can provide textual descriptions of transaction attributes extracted from a receive instruction (e.g., a receive instruction received from the client device 70) as input to a large language model trained to classify whether a transaction requires asset conversion operations. For example, the asset conversion agent 502 may extract an asset type identifier, a source account identifier, and a destination account identifier from a receive instruction, generate a natural language prompt comprising the extracted identifiers and contextual information about the transaction type, and transmit the prompt to a large language model that outputs a classification indicating whether tokenization or detokenization operations (e.g., whether asset conversion operations or an asset conversion) are required. The large language model may do so based on training indicating tokenization is required when transferring an asset from a conventional banking computing system to a DLT-based computing system, detokenization is required when transferring an asset from a DLT-based computing system to a conventional banking computing system, and no conversion is required when processing asset transfers between two computing systems of the same type. The large language model can generate an output comprising a binary classification value (e.g., conversion required or conversion not required) and/or a structured output identifying specific conversion operations to perform (e.g., tokenize asset A, map wallet identifier W to conventional account C, generate modified receive instruction for omnibus account O, etc.). In some cases, the asset conversion agent 502 may execute the large language model by transmitting the prompt to an inference server that hosts the model, receiving a response comprising the classification value and/or structured output, and storing the classification value in a variable or data structure.

The DLT application 60 can include the instruction generation agent 504. The instruction generation agent 504 can be a software component (e.g., a set of instructions) executed by one or more processors executing or processing the DLT application 60 to generate new instructions (e.g., new receive instructions) to use to complete asset transfers. For example, the instruction generation agent 504 can be implemented as a set of processor-executable instructions stored in memory that, when executed, generate new receive instructions with different ultimate destination accounts for pending asset transfers. The instruction generation agent 504 can execute one or more large language models to generate the new receive instruction based on transaction parameters and account mappings. In some cases, the instruction generation agent 504 can extract transaction attributes from the receive instruction received from the client device 70, format the attributes into a natural language prompt, and transmit the prompt to a large language model trained to generate transaction instructions for conventional banking computing systems. For example, the instruction generation agent 504 may extract an asset type identifier, a source account identifier, and a DLT-based client account identifier from the receive instruction, generate a prompt comprising the extracted identifiers and a request to identify a corresponding conventional account identifier, and transmit the prompt to a large language model that outputs a destination account identifier that maps to or otherwise corresponds to the DLT-based client account identifier for the specified asset type. The large language model can generate an output comprising the destination account identifier, a confidence score indicating a probability that the mapping is correct, and an explanation identifying features of the transaction and historical patterns that support the mapping. In some cases, the large language model or the instruction generation agent 504 may only replace the identifier of the destination account with the new identifier from the mapping (or generate the new instruction) responsive to determining the confidence score for the mapping exceeds or satisfies a threshold, otherwise, the DLT application 60 may generate an alert (e.g., via an interfacing agent 506) indicating an error. The instruction generation agent 504 may validate the output by comparing the destination account identifier with stored mapping data or by executing a second large language model trained to verify account mappings, and upon validation, incorporate the destination account identifier into the new receive instruction.

In some cases, the instruction generation agent 504 generates the new receive instruction using a mapping data structure stored by the DLT application 60 that associates or links wallet identifications with conventional account identifications in the banking computing system. For example, the instruction generation agent 504 can retrieve the identifier of the DLT-based client account from the receive instruction received from the client device 70. The instruction generation agent 504 can query the mapping data structure using the identifier of the DLT-based client account to identify a corresponding destination account identifier of an account of the conventional banking computing system. In some cases, the mapping data structure can include a separate entry for each asset type, such that the instruction generation agent 504 retrieves a destination account identifier based on both the identifier of the DLT-based client account and an asset type identifier extracted from the receive instruction. For example, the mapping data structure may store a first destination account identifier for securities accounts and a second destination account identifier for cash accounts, where both destination account identifiers map to the same DLT-based client account. The instruction generation agent 504 can incorporate the retrieved destination account identifier into the new receive instruction, which can otherwise include the same data except for the original DLT-based account identifier.

In some cases, the instruction generation agent 504 can execute a large language model trained to predict mapping relationships between DLT-based client accounts and conventional accounts based on historical transaction data and account attributes. For example, the instruction generation agent 504 may extract a wallet identifier from a receive instruction, generate a prompt comprising the wallet identifier and attributes of the transaction (e.g., asset type, transaction amount, counterparty identifier, timestamp, among others), and transmit the prompt to a large language model that predicts an identifier of a conventional account to which the wallet maps for the specified asset type. The large language model can generate an output comprising a predicted conventional account identifier, a confidence score indicating a probability that the prediction is correct, and/or an explanation identifying features of the transaction and historical patterns that support the prediction. In some cases, the large language model or the instruction generation agent 504 may only replace the identifier of the destination account with the new identifier from the mapping responsive to determining the confidence score for the mapping exceeds or satisfies a threshold, otherwise, the instruction generation agent 504 may generate an alert (e.g., via an interfacing agent 506) indicating an error.

The DLT application 60 can include the interfacing agent 506. The interfacing agent 506 can be a software component (e.g., a set of instructions) executed by one or more processors executing or processing the DLT application 60 to facilitate communication with users accessing client devices through one or more interface modalities. For example, the interfacing agent 506 can be implemented as a set of processor-executable instructions that generate, present, and process interactions with graphical user interfaces, application programming interfaces (APIs), and/or conversational chat interfaces. The interfacing agent 506 can communicate, through a chat interface, with a user accessing the client device 70 and receive, via a user input, a request to complete the asset transfer from the source account hosted in the banking computing system to the DLT-based client account. In some cases, the interfacing agent 506 can present prompts, questions, and/or confirmations to the user via the chat interface to request and/or retrieve transaction details, verify instructions, and/or obtain authorizations for asset transfers. The interfacing agent 506 may transmit data received from the user via the chat interface to other agents within the DLT application 60, such as the instruction generation agent 504 or a conflict detection agent 508 and/or, to process the request and execute the asset transfer. For instance, the interfacing agent 506 can parse natural language input from the user, extract transaction parameters, such as asset type, amount, source account, and/or destination account, and convert the parsed input into structured data for validation and instruction generation.

In some cases, the DLT application 60 may execute the instruction generation agent 504 only responsive to the asset conversion agent 502 determining an asset conversion is necessary for completing the asset transfer. In some cases, the asset conversion agent 502 can return a boolean value indicating whether asset conversion operations are required. The DLT application 60 can evaluate the boolean value to determine whether to invoke the instruction generation agent 504. For example, when the asset conversion agent 502 returns a positive indication, the DLT application 60 can trigger or execute the instruction generation agent 504 to generate a new receive instruction with a modified destination account identifier for the asset transfer. When the asset conversion agent 502 generates a negative indication, the DLT application 60 can proceed to complete the asset transfer without executing the instruction generation agent 504. In some cases, the DLT application 60 can perform the asset transfer without generating a new instruction by instead matching the receive instruction with a receive instruction received from another computing device (e.g., another computing device involved in the transaction, such as a computing device accessing an account to receive the asset of the asset transfer) and completing the asset transfer based on the match. The conditional execution of the instruction generation agent 504 can reduce computational overhead for transactions that do not require asset conversion operations, allowing the DLT application 60 to process such transactions with lower latency and resource consumption.

The interfacing agent 506 can operate as a conversational interface that receives textual input from a user via a chat interface and generates responsive textual outputs to guide the user through asset transfer operations. In some cases, the interfacing agent 506 can execute a large language model trained to interpret natural language transaction requests and generate prompts for eliciting additional transaction parameters from the user. For example, the interfacing agent 506 may receive a natural language input such as “transfer 1000 units of asset A from account X to wallet Y,” parse the input to identify the asset type, amount, source account identifier, and destination account identifier, and generate a confirmation prompt requesting the user to verify the extracted parameters before proceeding with the transfer. The interfacing agent 506 may transmit the natural language input as a prompt to a large language model that outputs a structured representation of the transaction request, including extracted parameter values and a confidence score indicating the probability that the extraction is correct. The interfacing agent 506 can present (e.g., responsive to determining the confidence score exceeds or satisfies a threshold) the structured representation to the user via the chat interface, allowing the user to confirm, modify, and/or reject the extracted parameters before the DLT application 60 initiates processing of the asset transfer.

The interfacing agent 506 can execute a large language model to generate natural language responses to user queries regarding account balances, transaction statuses, and/or available operations. In some cases, the interfacing agent 506 can receive a query from the user via the chat interface requesting information about a DLT-based client account balance, retrieve the current balance data from the DLT application 60 and/or the distributed ledger, format the balance data into a natural language prompt, and transmit the prompt to a large language model that generates a natural language response describing the account balance in conversational terms. For example, the interfacing agent 506 may receive a query such as “what is my balance for asset B,” retrieve the balance value from the DLT-based client account associated with the user, generate a prompt comprising the balance value and asset type, and transmit the prompt to a large language model that outputs a response such as “your current balance for asset B is 5000 units.” The interfacing agent 506 may display the generated response to the user via the chat interface, enabling the user to obtain account information through natural language interaction without accessing structured account reports and/or conventional user interfaces.

The DLT application 60 can include the conflict detection agent 508. The conflict detection agent 508 can be a software component (e.g., a set of instructions) executed by one or more processors executing or processing the DLT application 60 to identify errors, inconsistencies, and/or conflicts in user input and/or transaction instructions received from client devices. The conflict detection agent 508 can be implemented as a set of processor-executable instructions that apply validation rules, execute error-checking algorithms, and/or compare transaction parameters against stored data to detect discrepancies. The conflict detection agent 508 can determine whether a user input includes any errors for an asset transfer prior to the instruction generation agent 504 generating a receive instruction. In some cases, the conflict detection agent 508 can validate account identifiers, asset amounts, transaction types, and/or other parameters against predefined criteria and/or stored records to identify mismatches and/or invalid entries. For example, the conflict detection agent 508 may receive a parsed transaction request from the interfacing agent 506, extract parameter values such as a source account identifier and a destination account identifier, query a database to retrieve valid account identifiers, and compare the extracted identifiers with the retrieved valid identifiers to determine whether the user input specifies nonexistent accounts and/or accounts for which the user lacks authorization. The conflict detection agent 508 may execute the instruction generation agent 504 to generate a new receive instruction responsive to determining the user input does not include any errors for the asset transfer and/or determining any detected errors by the conflict detection agent 508 have been corrected.

The conflict detection agent 508 can interface with the interfacing agent 506 to detect conflicts and/or inaccurate data in user inputs received via a chat interface. In some cases, the conflict detection agent 508 can execute a large language model trained to identify errors, inconsistencies, and/or conflicts in transaction parameters extracted from natural language user inputs. For example, the conflict detection agent 508 may receive extracted parameter values from the interfacing agent 506, format the parameter values into a natural language prompt comprising the asset amount value, the asset type identifier, the source account identifier, and the destination account identifier, and transmit the prompt to a large language model that outputs a classification indicating whether any parameter values fail validation criteria. The large language model can generate an output comprising a binary classification value indicating whether errors are present, a structured output identifying specific validation failures (e.g., an asset amount exceeding an available balance, an invalid account identifier, an unsupported asset type, among others), and/or a confidence score indicating a probability that the classification is correct. The conflict detection agent 508 may execute the large language model by transmitting the prompt to an inference server that hosts the model, receiving a response comprising the classification value and/or structured output identifying detected errors, and storing the classification value in a variable for use in determining whether to trigger corrective actions via the interfacing agent 506. The conflict detection agent 508 can transmit error indications to the interfacing agent 506 responsive to the large language model identifying one or more validation failures (e.g., responsive to determining the confidence score for the validation failures is correct), which can trigger the interfacing agent 506 to generate a natural language prompt requesting the user to provide corrected parameter values. The interfacing agent 506 can receive corrected data from the user via the chat interface, extract corrected parameter values, and transmit the corrected values to the conflict detection agent 508 for re-validation by executing the large language model with a new prompt comprising the corrected parameter values.

Upon detecting one or more errors in user input, the conflict detection agent 508 can trigger the interfacing agent 506 to request additional data correcting the one or more errors through the chat interface. The instruction generation agent 504 may only generate a new receive instruction to complete the asset transfer responsive to or upon receiving corrected data that satisfies validation criteria. In some cases, the conflict detection agent 508 can execute a large language model trained to perform sequential validation operations on multiple attributes of a transaction request. The large language model can evaluate each attribute against corresponding validation criteria and generate error indications for any attributes that fail validation. For example, the conflict detection agent 508 may generate a prompt comprising the extracted transaction parameters and a request to validate each parameter according to predefined rules (e.g., such as by verifying that the source account identifier exists in a stored account registry, verifying that the asset amount is positive and within allowed limits, verifying that the asset type identifier matches an asset type supported by the source account, etc.), transmit the prompt to a large language model that outputs a structured validation result identifying failures in specific validation operations, and receive a response comprising error indications for each failed validation operation along with natural language explanations of the failures. The conflict detection agent 508 can transmit the error indications to the interfacing agent 506, triggering the interfacing agent 506 to generate a natural language prompt that identifies each error and requests corrected values for the failed parameters, present the prompt to the user via the chat interface, and receive corrected values from the user. The conflict detection agent 508 may receive the corrected values from the interfacing agent 506, generate a new prompt comprising the corrected values and the validation rules, transmit the new prompt to the large language model to re-execute validation operations using the corrected values, and determine whether the corrected values satisfy the validation criteria based on the model output. In doing so, the conflict detection agent 508 can enable the DLT application 60 to proceed with executing the instruction generation agent 504 to generate the new receive instruction responsive to the large language model confirming that all validation criteria are satisfied.

The DLT application 60 can include a ledger agent 510. The ledger agent 510 can be a software component (e.g., a set of instructions) executed by one or more processors executing or processing the DLT application 60 to complete assets transfers or otherwise communicate with DLT’s, such as the distributed ledger network 90. The ledger agent 510 can be implemented as a set of processor-executable instructions that can execute one or more large language models to generate instructions for updating the distributed ledger based on asset transfer details and transaction parameters. In some cases, the ledger agent 510 can extract transaction attributes from an indication of asset transfer completion received from the banking computing application, format the attributes into a natural language prompt, and transmit the prompt to a large language model trained to generate ledger update instructions formatted according to the second communication protocol. For example, the ledger agent 510 may extract an asset type identifier, an asset amount, a source account identifier, a DLT-based client account identifier, and a timestamp from the indication of completion, generate a prompt comprising the extracted identifiers and a request to format a ledger update instruction for the distributed ledger, and transmit the prompt to a large language model that outputs a structured instruction formatted according to a distributed ledger protocol used by the distributed ledger network. The large language model can generate an output comprising the structured instruction, a confidence score indicating a probability that the instruction satisfies format requirements for the second communication protocol, and an explanation identifying features of the transaction that support the generated instruction format. The ledger agent 510 can execute the large language model by transmitting the prompt to an inference server that hosts the model and receiving a response comprising the formatted ledger update instruction The ledger agent 510 can cryptographically sign the instruction using a private key associated with the DLT application 60 or the DLT-based client account before transmitting the signed instruction to validator nodes of the distributed ledger network. The ledger agent 510 can transmit the generated instructions (e.g., responsive to determining the probability that the instruction satisfies the formatting requirements (e.g., of the second communication protocol) to the distributed ledger network 90 to cause the distributed ledger network 90 to update a distributed ledger based on the asset transfer, such as by appending a new block instance to the distributed ledger for the asset transfer.

In some cases, the ledger agent 510 can execute a large language model trained to predict ledger state changes and validate consistency of proposed updates across multiple assets or account relationships. The ledger agent 510 can generate a prompt comprising the asset type, the asset amount, the DLT-based client account identifier, and current ledger state data retrieved from the distributed ledger, and transmit the prompt to a large language model that outputs a predicted ledger state after applying the asset transfer along with a validation output indicating whether the predicted state satisfies consistency constraints. For example, the large language model may generate an output comprising a predicted balance value for the DLT-based client account after crediting the asset, a predicted aggregate balance value across all accounts holding the asset type, and a validation classification indicating whether the predicted aggregate balance matches expected constraints based on omnibus account balances in the banking computing system. The ledger agent 510 may receive the output from the large language model, compare the predicted balance values with constraint values retrieved from the banking computing application or stored mapping data, and responsive to the validation classification indicating that consistency constraints are satisfied, transmit the ledger update instruction to the distributed ledger network to add the record of the asset transfer. The ledger agent 510 can execute a second large language model to generate transaction status messages or end-of-day statements for transmission to the client device by formatting transaction details and predicted ledger state changes into natural language outputs that describe the completion of the asset transfer and the updated DLT-based client account balance.

In operation, the DLT application 60’s position within the system 500 can enable the DLT application 60 to perform an end-to-end process for an asset transfer between a conventional account hosted in a conventional banking computing and a wallet hosted or operated using a distributed ledger computing system. For example, the DLT application 60 can establish a first connection with a banking computing application executed by the banking computing system and a second connection with one or more nodes hosting a distributed ledger via a second communication protocol. The DLT application 60 can receive a receive instruction from the client device 70 through the first connection using the first communication protocol. The receive instruction can identify a source account hosted in the banking computing system and a DLT-based client account (e.g., the wallet 61, the wallet 62, or the wallet 63) as a destination for the asset transfer. In some cases, the DLT application 60 can receive the receive instruction after the interfacing agent 506 communicates with a user accessing the client device 70 via a chat interface to obtain transaction details, parse a natural language input from the user to extract transaction parameters, and format the extracted parameters into a structured receive instruction.

The DLT application 60 can execute the asset conversion agent 502 to determine whether asset conversion operations are necessary for completing the asset transfer between the banking computing system and the distributed ledger. The asset conversion agent 502 can analyze attributes of the receive instruction, such as the asset type, the source account type, and the destination account type, to identify whether the transaction requires tokenization, account mapping operations, or other conversion operations. Responsive to the asset conversion agent 502 determining that asset conversion is required, the DLT application 60 can execute the instruction generation agent 504 to generate a new receive instruction that includes an identification of a destination account in the set of financial applications 40 that replaces the DLT-based client account from the original receive instruction, the identifier of the source account, and the asset being transferred to the destination account. The instruction generation agent 504 can access a mapping data structure stored by the DLT application 60 that associates wallet identifications with conventional account identifications, retrieve the appropriate destination account identifier based on the DLT-based client account identifier and the asset type, and format the new receive instruction according to the first communication protocol standards (e.g., ISO15022 or ISO20022).

The instruction generation agent 504 can transmit the new receive instruction to the banking computing application. The banking computing application can receive the new receive instruction and process the new receive instruction to complete the asset transfer. In some cases, the banking computing application can do so based on a receive instruction received from a different client device. For instance, the banking computing application can receive another receive instruction from a different client device involved in the asset transfer. The banking computing application can compare the received instructions together, such as by comparing attributes of the instructions with each other. Responsive to determining the instructions match, the banking computing application can complete or settle the asset transfer. The banking computing application can transmit an indication of the completion of the asset transfer to the DLT application 60 responsive to completing the transfer of the asset from source account to the newly determined destination account.

The DLT application 60 can receive an indication of completion of the asset transfer from the banking computing application over the established first connection and via the first communication protocol. The indication of completion may be a credit confirmation message formatted according to a conventional message standard (e.g., an MT544 message for securities or an MT910 message for cash) indicating that the asset has been credited to the destination account in the banking computing system. In some cases, the DLT application 60 can receive the indication of completion after the banking computing application executes settlement operations that debit the source account and credit the destination account. The banking computing application can transmit the credit confirmation message to the DLT application 60 via the established first connection. The DLT application 60 may parse the indication of completion to extract transaction identifiers, asset amounts, and account identifiers that the DLT application 60 uses to verify that the received confirmation corresponds to the receive instruction transmitted earlier. The DLT application 60 can store the indication of completion in association with the transaction record maintained by the DLT application 60, such that the transaction record reflects the successful settlement of the asset transfer in the banking computing system.

Upon receiving the indication of completion, the DLT application 60 can execute the ledger agent 510 to generate an instruction to cause the one or more nodes maintaining the distributed ledger to add a record of the asset transfer to the distributed ledger. In doing so, the DLT application 60 can update the DLT-based client account. The ledger agent 510 can generate a transaction instruction formatted according to the second communication protocol, cryptographically sign the instruction using a private key associated with the DLT application 60 or the DLT-based client account, and transmit the signed instruction to validator nodes of the distributed ledger network (e.g., nodes of the DLT network 90) for inclusion in a subsequent block. In some cases, the ledger agent 510 can generate the transaction instruction by formatting a ledger update message that includes the asset type, the asset amount, the identifier of the DLT-based client account, a timestamp, and a transaction reference number. The ledger agent 510 may apply cryptographic signing operations to the ledger update message using a private key retrieved from a key storage location, such that the signed message can be validated by the validator nodes of the distributed ledger network using a corresponding public key. The ledger agent 510 can transmit the signed instruction to the distributed ledger network over the established second connection, where the validator nodes execute consensus operations to verify the signed instruction and add the record of the asset transfer to the distributed ledger, and the DLT-based client account balance is updated to reflect the completed asset transfer.

The DLT application 60 can similarly facilitate or complete asset transfers from conventional banking computing systems to DLT-based computing systems, from DLT-based computing systems to conventional banking computing systems, and/or between computing systems of the same type.

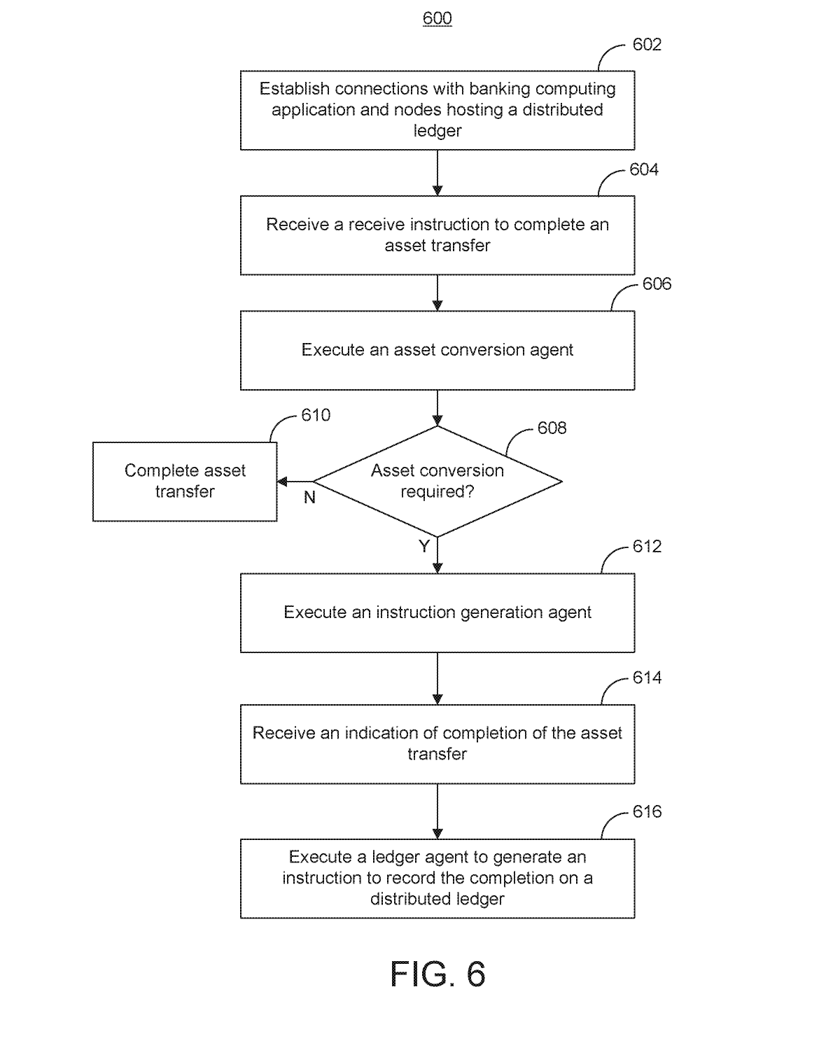

Referring now to FIG. 6, illustrated is a flowchart depicting a method 600 for seamlessly processing transactions using distributed ledger technology with an agentic architecture, in accordance with one or more implementations. The method 600 describes how a distributed ledger technology application can facilitate asset transfers between a conventional computing system and a distributed ledger by executing one or more agents to coordinate operations across different communication protocols. The DLT application may be the DLT application 60, shown and described with reference to FIG. 1 and FIG. 5. The method 600 is described below with reference to components (e.g., the banking computing system, the DLT application 60, the client device 70, and the distributed ledger network 90) of the system 500 as the system 500 is described with reference to FIG. 5 above. However, it should be noted that the method 600 may be performed by any number of components. Furthermore, other configurations of the method 600 may comprise additional or alternative steps or may omit one or more steps altogether.

At step 602, the DLT application 60 can establish connections with banking computing application and nodes hosting a distributed ledger. The DLT application 60 can establish a first connection with a banking computing application executed by the banking computing system via a first communication protocol and a second connection with one or more nodes hosting a distributed ledger via a second communication protocol. For example, the DLT application 60 can establish a first connection using a conventional communication protocol such as SWIFT or ISO20022 messaging standards to exchange messages with the banking computing system. In some cases, the DLT application 60 can establish the connections upon receiving a transaction request (e.g., a request for an asset transfer) from the client device 70 that requires interaction with both the banking computing system and the distributed ledger network 90. In some cases, the DLT application 60 can establish the connections prior to and/or irrespective of receiving any particular transaction requests such that the DLT application 60 can use the already existing connections to complete a transaction request upon receipt of the transaction request, reducing latency in communication between client devices that transmit such requests and respective computing systems involved in completing the requests. The DLT application 60 may establish the first connection by authenticating with the banking computing application using stored credentials, establishing a secure communication channel, and exchanging handshake messages to verify the connection. The DLT application 60 can establish the second connection by connecting to one or more nodes of the distributed ledger network 90, authenticating using cryptographic keys.

The connections can be established during an initialization phase of the DLT application 60 or in response to a transaction request from the client device 70. In some cases, the DLT application 60 can establish the first connection during a system startup operation in which the DLT application 60 retrieves stored authentication credentials, transmits a connection request to the banking computing system, receives a connection acknowledgment, and stores connection state data indicating that the first connection is active. For example, the DLT application 60 may transmit a SWIFT login message comprising an identifier of the DLT application 60 and authentication data to the banking computing system, receive a SWIFT acknowledgment message indicating successful authentication, and store a session identifier received in the acknowledgment message for use in subsequent message transmissions. The DLT application 60 can establish the second connection by transmitting a connection request to a validator node of the distributed ledger network 90. The connection request can include a public key associated with the DLT application 60. The DLT application 60 can receive a connection acknowledgment from the validator node after the validator node verifies the public key.

At step 604, the DLT application 60 can receive a receive instruction to complete an asset transfer. The DLT application 60 can receive the receive instruction from the client device 70 through a connection using the first communication protocol (e.g., the same communication protocol that the DLT application 60 uses to communicate with the banking computing system). The receive instruction can be a message including an instruction to complete an asset transfer to transfer an asset from a source account hosted in the banking computing system to a DLT-based client account associated with the distributed ledger network 90. The receive instruction can include an identifier of the source account and an identifier of the DLT-based client account. In some cases, the receive instruction can include an identifier specific to the DLT application 60, such as a BIC code, that can be used to route the receive instruction to the DLT application 60. In some cases, the receive instruction can be transmitted from the client device 70 using a conventional messaging format such as an MT542 message for securities transfers or an MT202 message for cash transfers, with the message identifying the source account by a conventional account number and the DLT-based client account by a wallet identifier or a mapped account number.

For example, the receive instruction may specify a source account identifier “ACC-12345” in a source account field of an MT542 message, a wallet identifier “WALLET-67890” in an ultimate beneficiary field, and an asset identifier “ISIN-XYZ” in an asset field, such that the DLT application 60 can extract each identifier by parsing the MT542 message according to the ISO15022 standard and retrieving field values from their respective positions in the message structure. In some cases, the DLT application 60 can receive the receive instruction from the banking computing system over the established first connection using the first communication protocol. The DLT application 60 can parse the message to extract transaction parameters including the asset type, the asset amount, the source account identifier, and the destination account identifier, and validate the message format and content against predefined validation rules. The DLT application 60 can store the transaction parameters in memory, initiate validation checks to verify account existence and authorization, and trigger execution of one or more agents (e.g., the asset conversion agent 502, the instruction generation agent 504, or the conflict detection agent 508) to process the transaction request.

In some cases, the DLT application 60 can receive the receive instruction in response to a user at the client device 70 initiating a tokenization transaction to move assets from the banking computing system onto the distributed ledger network 90. In some cases, the DLT application 60 can receive the receive instruction after the user submits a transaction request via a conventional user interface 71 or an application interface 72, where the interface formats the request into a standardized message for transmission to the DLT application 60. For example, the user may enter transaction details including the source account identifier, the destination account identifier, and the asset amount into a graphical user interface presented by the conventional user interface 71, and the conventional user interface 71 may generate an MT542 message by populating message fields with the entered transaction details and transmitting the MT542 message to the DLT application 60 via a SWIFT network using the BIC code 64 as a routing address. The DLT application 60 may receive the receive instruction by monitoring incoming messages on the first connection associated with the BIC code 64, detecting an MT542 message addressed to the BIC code 64, and extracting the message content for processing.

In some cases, the DLT application 60 can execute the interfacing agent 506 to facilitate communication with a user accessing the client device 70 through a chat interface to receive and/or complete the asset transfer of the asset from the source account hosted in the banking computing system to the DLT-based client account. For example, the interfacing agent 506 can generate and/or present a conversational interface on the client device 70. The conversational interface can be configured to receive textual input and/or other types of input (e.g., selections of indicators on the user interface) from the user in the receive instruction. The interfacing agent 506 can parse the input to extract or identify transaction parameters such as the asset type, the asset amount, source account identifier, and/or destination account identifier. The interfacing agent 506 can generate a structured transaction request based on the extracted parameters. For example, the interfacing agent 506 may receive a natural language input such as “transfer 1000 units of asset A from account X to wallet Y,” extract the asset amount value of 1000, the asset type identifier “A,” the source account identifier “X,” and the destination account identifier “Y” from the textual input, and format the extracted parameters into a receive instruction.

In some cases, the interfacing agent 506 can elicit additional data for the transaction request. For example, the interfacing agent 506 can execute a large language model trained to interpret natural language transaction requests and generate prompts requesting additional transaction parameters from the user when the initial user input does not include all necessary parameters for completing the asset transfer. The interfacing agent 506 may transmit the parsed user input to other agents within the DLT application 60, such as the conflict detection agent 508 and/or the asset conversion agent 502, to validate the transaction request and determine whether asset conversion operations are necessary before executing the asset transfer. The interfacing agent 506 can generate confirmation prompts requesting the user to verify the extracted parameters before the DLT application 60 initiates processing of the asset transfer and can receive a confirmation input from the user via the chat interface indicating approval to proceed with the transaction. The interfacing agent 506 can transmit the receive instruction to the instruction generation agent 504 responsive to receiving the confirmation input from the user, thereby initiating the asset transfer process described herein.

At step 606, the DLT application 60 can execute the asset conversion agent 502. The DLT application 60 can execute the asset conversion agent 502 to determine whether any asset conversion is required to complete the transfer between the banking computing system and the distributed ledger network 90. The asset conversion agent 502 can analyze attributes of the receive instruction, such as the asset type, the source account type, and the destination account type, to identify whether the transaction requires tokenization, account mapping operations, and/or other conversion operations. In some cases, the asset conversion agent 502 can execute a set of instructions that compare attributes of the source account and the DLT-based client account against stored mapping data, apply a set of rules to identify discrepancies between asset formats and/or account structures, and generate a determination indicating whether asset conversion operations are necessary. For example, the asset conversion agent 502 may retrieve a source account type identifier from the receive instruction, query a mapping data structure that associates account type identifiers with conversion requirement indicators, and compare the source account type identifier with a DLT-based account type identifier to determine whether to tokenize or detokenize the asset to complete the asset transfer. The asset conversion agent 502 can determine whether asset conversion operations are required, for example, by determining whether the asset is being transferred between computing systems of different types (e.g., from a conventional computing system to a DLT-based computing system or from a DLT-based computing system to a conventional computing system). The asset conversion agent 502 can determine that no asset conversion is required when both the source account and the destination account in the receive instruction are hosted on the same computing system. The asset conversion agent 502 can be executed after receiving the receive instruction in step 604 and before proceeding with further transaction processing. The asset conversion agent 502 can generate or return a Boolean value and/or a status indicator to the DLT application 60. A positive indication (e.g., a one) can trigger execution of the instruction generation agent 504 in step 612, and a negative indication (e.g., a zero) can cause the method 600 to proceed to completing the asset transfer in step 610 without generating additional receive instructions.

In some cases, the asset conversion agent 502 can execute a large language model trained to analyze transaction attributes to determine whether an asset conversion is required (e.g., to determine whether to initiate an asset conversion flow through the instruction generation agent 504). The asset conversion agent 502 may extract the asset type identifier, the source account identifier, and the destination account identifier from the receive instruction. The asset conversion agent 502 can generate a natural language prompt comprising the extracted identifiers and contextual information about the transaction type. The asset conversion agent 502 can transmit the prompt to a large language model that outputs a classification indicating whether tokenization, detokenization, and/or account mapping operations are required. For example, the asset conversion agent 502 may generate a prompt comprising text such as “determine whether conversion is required for transferring asset type ISIN-XYZ from conventional account ACC-12345 to DLT wallet WALLET-67890,” transmit the prompt to an inference server that hosts the large language model, and receive a response comprising a binary classification value indicating whether conversion is required along with a structured output identifying specific conversion operations to perform. The large language model can generate an output comprising the classification value, a confidence score indicating a probability that the classification is correct, and/or an explanation identifying features of the transaction and historical patterns that support the classification. The asset conversion agent 502 may store the classification value and/or other generated data in a variable or data structure for use in determining whether to execute the instruction generation agent 504.

At step 608, the DLT application 60 can determine whether an asset conversion is required for the transaction request. The DLT application 60 can perform the determination based on an output from the asset conversion agent 502. For example, the DLT application 60 can retrieve and identify the output from the asset conversion agent 502 from memory or the variable in which the output. The DLT application 60 can determine an asset conversion is required for the asset transfer based on the output (e.g., the DLT application 60 can determine an asset conversion is required based on the output being a one or another positive indicator or determine an asset conversion is not required based on the output being a zero or another negative indicator). In some cases, the DLT application 60 can compare the confidence score for the classification to a threshold and only make a determination as to whether an asset conversion is required responsive to determining the confidence score exceeds the threshold, otherwise, the DLT application 60 can rerun the asset conversion agent 502 with additional data. The DLT application 60 can receive the additional data received as input from the chat interface accessed by the user in response to the interfacing agent 506 requesting additional data responsive to the DLT application 60 determining the confidence score did not exceed the threshold. The DLT application 60 can repeat this process until determining a confidence score for a determination exceeds or satisfies the threshold.

In response to determining an asset conversion is not required, at step 610, the DLT application 60 can complete the asset transfer. The DLT application 60 can complete the asset transfer using techniques specific to the computing system or computing systems involved in the transfer. In one example, the DLT application 60 can complete the asset transfer based on receipt of a matching receive instruction from another computing device associated with transfer request. For instance, the DLT application 60 can receive a second receive instruction and compare the second receive instruction with the original receive instruction. The DLT application 60 can perform the comparison by comparing the attributes and/or values of the respective receive instructions. The DLT application 60 can determine a match based on each of the attributes matching or otherwise a predefined number or set of attributes matching between the two receive instructions. The DLT application 60 can complete (or settle) the asset transfer based on the two receive instructions matching and/or responsive to determining any other conditions are satisfied (e.g., as described with reference to FIG. 4). In one example, the DLT application 60 may complete the asset transfer by transmitting a confirmation message to the banking computing system, receiving a settlement confirmation from the banking computing application indicating successful crediting of the asset to the DLT-based client account, and proceeding to step 616 to execute the ledger agent 510 to update the distributed ledger based on the asset transfer, as described below.

In some cases, the DLT application 60 can receive the indication of completion from the banking computing application over the established first connection using the first communication protocol, such as an MT544 message for securities and/or an MT910 message for cash, where the indication of completion identifies the source account, the DLT-based client account, and/or the asset amount transferred. The DLT application 60 may parse the indication of completion to extract transaction identifiers, asset type identifiers, and/or account identifiers, and validate that the extracted identifiers match parameters in the receive instruction received from the client device 70 in step 604. The DLT application 60 can store a transaction record associating the receive instruction with the indication of completion in memory, such that the transaction record reflects successful settlement of the asset transfer in the banking computing system. The DLT application 60 may transmit a credit confirmation message to the client device 70 via the first communication protocol and/or via a custom communication protocol, where the credit confirmation message indicates successful completion of the asset transfer and identifies the updated balance of the DLT-based client account. In some cases, the DLT application 60 can generate an end-of-day statement comprising transaction details for the asset transfer, including the source account identifier, the DLT-based client account identifier, the asset type, the asset amount, and/or a timestamp, and transmit the end-of-day statement to the client device 70 via the first communication protocol.

However, in response to determining an asset conversion is required at step 608, at step 612, the DLT application 60 can execute the instruction generation agent 504. The DLT application 60 can execute the instruction generation agent 504 to generate a new receive instruction. The new receive instruction can include an identification of a destination account replacing the DLT-based client account from the original receive instruction, the identifier of the source account, and the asset being transferred to the destination account. The new receive instruction can be configured for transmission to the banking computing application executed by the banking computing system to complete the asset transfer, in some cases. The instruction generation agent 504 can populate the new receive instruction with the retrieved destination account identifier, the source account identifier, and asset transfer details.

The DLT application 60 can execute the instruction generation agent 504 to determine or select the destination account to replace the DLT-based client account for the new receive instruction. The instruction generation agent 504 can select the destination to replace the DLT-based client account using the methods described herein. In some cases, the instruction generation agent 504 can do so by accessing a mapping data structure stored by the DLT application 60 that associates wallet identifications with conventional account identifications. In some cases, the DLT-based client account maps to an omnibus account in the banking computing system. In such cases, the instruction generation agent 504 can generate the new receive instruction that specifies the omnibus account as the destination account. The instruction generation agent 504 can retrieve the appropriate destination account identifier based on the DLT-based client account identifier mapping to the destination account identifier in the mapping.

In some cases, the instruction generation agent 504 can execute a machine learning model (e.g., a large language model) trained or otherwise configured to predict and/or identify the destination account based on the identification of the DLT-based client account. For example, the instruction generation agent 504 can generate a prompt that includes the DLT-based client account identifier extracted from the receive instruction, the asset type identifier, and contextual parameters such as transaction amount, timestamp, and/or counterparty identifier. The instruction generation agent 504 can transmit (e.g., via an application programming interface (API) for the large language model) the prompt to the large language model that outputs a destination account identifier corresponding to a conventional account in the banking computing system to which the DLT-based client account maps for the specified asset type. The large language model can generate an output that includes the destination account identifier, a confidence score indicating a probability that the predicted destination account identifier is correct, and/or an explanation identifying features of the transaction and historical patterns that support the prediction. The instruction generation agent 504 may receive the output from the large language model. The instruction generation agent 504 can incorporate the destination account identifier into the new receive instruction formatted according to the first communication protocol. The instruction generation agent 504 can transmit the new receive instruction to the banking computing application executed by the banking computing system to initiate settlement operations for the asset transfer.

In some cases, the DLT application 60 can execute the conflict detection agent 508 to determine whether a user input includes any errors for the asset transfer prior to generating the new receive instruction. The conflict detection agent 508 can compare account identifiers, asset amounts, transaction types, and/or other parameters with predefined criteria and/or stored records to identify mismatches and/or invalid entries. For example, the conflict detection agent 508 can receive a parsed transaction request from the interfacing agent 506, extract parameter values such as a source account identifier and a destination account identifier, query a database to retrieve valid account identifiers, and compare the extracted identifiers with the retrieved valid identifiers to determine whether the user input specifies nonexistent accounts and/or accounts for which the user lacks authorization. The DLT application 60 may execute the instruction generation agent 504 to generate the new receive instruction responsive to the conflict detection agent 508 determining the user input does not include any errors for the asset transfer. In some cases, the DLT application 60 can execute the instruction generation agent 504 to generate the new receive instruction responsive to the conflict detection agent 508 determining any detected errors by the conflict detection agent 508 have been corrected. The conflict detection agent 508 may store a result indicating whether the user input satisfies validation criteria, and the DLT application 60 can evaluate the validation result to determine whether to invoke the instruction generation agent 504. The conflict detection agent 508 can generate an error message identifying one or more validation failures responsive to detecting errors in the user input, and the DLT application 60 can transmit the error message to the interfacing agent 506 to request corrected parameter values from the user via the chat interface.

In an example, the conflict detection agent 508 can execute a large language model trained to identify errors, inconsistencies, and/or conflicts in transaction parameters extracted from natural language user inputs. The conflict detection agent 508 may receive extracted parameter values from the interfacing agent 506, format the parameter values into a natural language prompt comprising the asset amount value, the asset type identifier, the source account identifier, and the destination account identifier, and transmit the prompt to a large language model that outputs a classification indicating whether any parameter values fail validation criteria. The large language model can generate an output comprising a binary classification value indicating whether errors are present, a structured output identifying specific validation failures (e.g., an asset amount exceeding an available balance, an invalid account identifier, an unsupported asset type, among others), and/or a confidence score indicating a probability that the classification is correct. The conflict detection agent 508 may execute the large language model by transmitting the prompt to an inference server that hosts the model and receiving a response comprising the classification value and/or structured output identifying detected errors. The conflict detection agent 508 can store the classification value in a variable for use in determining whether to trigger corrective actions via the interfacing agent 506. The conflict detection agent 508 can transmit error indications to the interfacing agent 506 responsive to the large language model identifying one or more validation failures. Receipt of the error indications can trigger the interfacing agent 506 to generate a natural language prompt requesting the user to provide corrected parameter values. The interfacing agent 506 can receive corrected data from the user via the chat interface, extract corrected parameter values, and transmit the corrected values to the conflict detection agent 508 for re-validation by executing the large language model with a new prompt comprising the corrected parameter values.

The instruction generation agent 504 (or another agent, such as a transfer completion agent) can complete the asset transfer using the methods described herein (e.g., via steps 202, 210, 212, 214, 216, 218, and 220 of the method 200 or via steps 310-322 of the method 300, depending on whether the asset transfer is from a conventional account to a DLT-based account, or vice-versa). For example, the instruction generation agent 504 can receive another receive instruction from another client device involved in the transaction (e.g., a client device of the other party to the asset transfer). The instruction generation agent 504 can compare the receive instruction to the newly generated receive instruction, such as by comparing attributes or values of the respective receive instructions. Responsive to determining a match, the instruction generation agent 504 can settle the asset transfer and operate accordingly to complete the asset transfer, as described herein. In some cases, the instruction generation agent 504 can transmit the new receive instruction to the conventional banking application and the conventional banking application can receive the second receive message and perform the matching.

At step 614, the DLT application 60 can receive an indication of completion of the asset transfer. The DLT application 60 can receive the indication of completion from the banking computing application executed by the banking computing system over the established first connection via the first communication protocol. In some cases, the banking computing application may transmit a credit confirmation message formatted according to a conventional message standard such as an MT544 message for securities transfers and/or an MT910 message for cash transfers. The credit confirmation message can indicate that the asset has been credited to the destination account in the banking computing system. The DLT application 60 can receive the indication of completion after the banking computing system has settled the asset transfer by debiting the asset from the source account and crediting the asset to the destination account. The DLT application 60 may receive the indication of completion in response to the DLT application 60 transmitting the new receive instruction generated at step 612 to the banking computing application. In some cases, the DLT application 60 may receive the indication of completion in response to settlement operations initiated by the banking computing system based on matching instructions from the source account and the destination account or another computing device involved in processing or completing the asset transfer. The DLT application 60 may receive the indication of completion by monitoring incoming messages over the established first connection, parsing received messages to identify confirmation messages related to the asset transfer, extracting transaction details from the confirmation message, and validating that the confirmation matches the original receive instruction parameters. The DLT application 60 can update internal transaction records to reflect the settlement in the banking computing system. The DLT application 60 can trigger execution of the ledger agent 510 to update the distributed ledger based on the asset transfer. The DLT application 60 can prepare status messages for transmission to the client device 70 that initiated the transaction.

At step 616, the DLT application 60 can execute the ledger agent 510 to generate an instruction to record the completion on the distributed ledger. The DLT application 60 can execute the ledger agent 510 to generate an instruction configured to cause the one or more nodes maintaining the distributed ledger to add a record of the asset transfer (e.g., a record, such as a block of a blockchain, that contains the data for the asset transfer) to the distributed ledger over the established second connection via the second communication protocol corresponding to communication with the distributed ledger network 90. The DLT application 60 (e.g., via the ledger agent 510) can transmit the generated instruction to the distributed ledger network 90. The nodes maintaining the distributed ledger network 90 can receive the instruction and add the record to the distributed ledger of the distributed ledger network 90. In some cases, the DLT application 60 can execute the ledger agent 510 after confirming that the asset transfer has been settled in the banking computing system. The DLT application 60 can execute the ledger agent 510 automatically in response to receipt of the indication of completion.

The ledger agent 510 may generate the instruction by formatting a ledger update message that includes the asset type, the asset amount, the source account identifier, the destination account identifier, a timestamp, and/or a transaction reference number. The ledger agent 510 can apply cryptographic operations to sign the message. The ledger agent 510 can transmit the signed message to the distributed ledger network 90 over the established second connection using the second communication protocol. The ledger agent 510 can receive a confirmation from the distributed ledger network 90 indicating successful addition of the record to the distributed ledger. The ledger agent 510 can update the DLT-based client account balance in the DLT application 60. The ledger agent 510 can generate transaction status messages and/or end-of-day statements for transmission to the client device 70. In some cases, the ledger agent 510 can transmit confirmation messages to the banking computing application to reconcile balances across systems.

The DLT application 60 can execute a delivery instruction process for asset transfers from a DLT-based computing system to a conventional computing system using operations similar to those described with reference to the receive instruction process. For example, the DLT application 60 can receive a deliver instruction from the client device 70 through a communication protocol specific to a DLT-based computing system. The deliver instruction can be a message including an instruction to complete an asset transfer to transfer an asset from a DLT-based client account associated with the distributed ledger network 90 to a destination account hosted in the banking computing system. The deliver instruction can include an identifier of the DLT-based client account and an identifier of the destination account. The DLT application 60 can execute the asset conversion agent 502 to determine whether any asset conversion is required to complete the transfer between the distributed ledger network 90 and the banking computing system. Responsive to the asset conversion agent 502 determining an asset conversion is required (e.g., based on the accounts for the transfer being in different types of computing systems), the DLT application 60 can execute the instruction generation agent 504 to generate a new deliver instruction that includes an identification of a source account in the set of financial applications 40 that replaces the DLT-based client account from the original deliver instruction, the identifier of the destination account, and the asset being transferred to the destination account. The instruction generation agent 504 can access the mapping data structure stored by the DLT application 60 to retrieve the appropriate source account identifier based on the DLT-based client account identifier and the asset type. The DLT application 60 can transmit the new deliver instruction to the banking computing application executed by the banking computing system using the first communication protocol. The DLT application 60 can receive an indication of completion of the asset transfer from the banking computing application over the established first connection via the first communication protocol. The indication of completion can be a debit confirmation message formatted according to a conventional message standard. The DLT application 60 can execute the ledger agent 510 to generate an instruction to cause the one or more nodes maintaining the distributed ledger to add a record of the asset transfer to the distributed ledger, thereby updating the DLT-based client account to reflect the debiting of the asset.

In a non-limiting example, the DLT application 60 can establish a first connection with the banking computing application executed by the banking computing system using a conventional communication protocol such as SWIFT messaging and/or ISO20022 standards. The DLT application 60 can transmit authentication credentials to the banking computing system, receive a connection acknowledgment message, and store connection state data indicating that the first connection is active. The DLT application 60 can establish a second connection with validator nodes of the DLT network 90 using a blockchain-specific protocol. The DLT application 60 can transmit a connection request to a validator node of the DLT network 90.

The DLT application 60 can receive a receive instruction from the client device 70 through the first connection using the first communication protocol. The receive instruction can be formatted as an MT542 message for securities transfers and/or an MT202 message for cash transfers. The receive instruction can specify a source account identifier in a source account field of the message, a wallet identifier in a beneficiary field, and an asset identifier in an asset field. The DLT application 60 can parse the message to extract or identify transaction parameters including the asset type, the asset amount, the source account identifier, and the wallet identifier corresponding to the DLT-based client account. The DLT application 60 can validate the message format and content against predefined validation rules, store the transaction parameters in memory, and initiate validation checks to verify account existence and authorization. The DLT application 60 can execute the asset conversion agent 502 to determine whether any asset conversion is required to complete the transfer between the banking computing system and the DLT network 90.

The asset conversion agent 502 can analyze attributes of the receive instruction, such as the asset type, the source account type, and the destination account type, to identify whether the transaction requires tokenization, account mapping operations, and/or other conversion operations. The asset conversion agent 502 can retrieve a source account type identifier from the receive instruction, query a mapping data structure that associates account type identifiers with conversion requirement indicators, and compare the source account type identifier with a DLT-based account type identifier to determine whether the asset may be tokenized before crediting to the DLT-based client account. Responsive to the asset conversion agent 502 determining that asset conversion is required, the DLT application 60 can execute the instruction generation agent 504 to generate a new receive instruction. The instruction generation agent 504 can access a mapping data structure stored by the DLT application 60 that associates wallet identifications with conventional account identifications, retrieve a destination account identifier based on the DLT-based client account identifier and the asset type. The new receive instruction can include the destination account identifier, the source account identifier, and the asset being transferred to the destination account. The DLT application 60 can transmit the new receive instruction to the banking computing application executed by the banking computing system using the first communication protocol.

The DLT application 60 can receive an indication of completion of the asset transfer from the banking computing application over the established first connection via the first communication protocol. The indication of completion can be a credit confirmation message formatted as an MT544 message for securities and/or an MT910 message for cash, where the indication of completion can identify the source account, the destination account in the FI Applications 40, and the asset amount transferred. The DLT application 60 can parse the indication of completion to extract transaction identifiers, asset type identifiers, and account identifiers, and validate that the extracted identifiers match parameters in the receive instruction received from the client device 70. The DLT application 60 can execute the ledger agent 510 to generate an instruction to cause the one or more nodes maintaining the distributed ledger to add a record of the asset transfer to the distributed ledger. The ledger agent 510 can format a ledger update message that includes the asset type, the asset amount, the source account identifier, the destination account identifier, a timestamp, and a transaction reference number. The ledger agent 510 can apply cryptographic signing operations to the ledger update message using a private key retrieved from a key storage location, such that the signed message can be validated by the validator nodes of the DLT network 90 using a corresponding public key. The ledger agent 510 can transmit the signed instruction to the DLT network 90 over the established second connection, where the validator nodes can execute consensus operations to verify the signed instruction and add the record of the asset transfer to the distributed ledger, thereby updating the DLT-based client account balance to reflect the completed asset transfer.

The agentic architecture of the DLT application 60 can reduce the processing overhead of processing asset transfers between different computing systems. For instance, in some cases, other systems may require continuous configuration of transaction routing rules for each combination of asset type, account type, and/or destination account, that involve static mappings between DLT-based client accounts and conventional accounts in the banking computing system prior to processing any transactions. The agentic architecture can execute a large language model trained to analyze transaction attributes and determine conversion requirements without relying on pre-configured static mappings, thereby reducing the computational overhead and configuration complexity associated with maintaining static routing rules for each possible combination of transaction parameters. The agentic architecture can use machine learning models to determine destination account identifiers that can be trained over time to adapt to changes in the inter-operating systems. Additionally, implementing the agentic architecture can reduce latency in transaction processing when determining conversion requirements, which can otherwise require or involve executing multiple database queries and rule evaluations that may be required by non-agentic systems to determine appropriate routing paths for transactions.

In some aspects, the techniques described herein relate to a method for enabling transfers across different communication protocols using distributed ledger technology (DLT), including: establishing, by a DLT application executed by one or more processors, a first connection using a first communication protocol to an application executed by a computing system, and a second connection using a second communication protocol to one or more nodes hosting a distributed ledger; receiving, by the DLT application and from a client device, a transfer instruction configured for transmission to the application to transfer from a source in the computing system to a DLT-based client destination, the transfer instruction including an identifier of the source and an identifier of the DLT-based client destination; responsive to determining, by the DLT application by triggering execution of a conversion agent, that a conversion is required for the transfer, generating, by the DLT application by triggering execution of an instruction generation agent, a modified transfer instruction including an identifier of a second destination replacing the DLT-based client destination; receiving, by the DLT application using the first communication protocol and from the application, an indication of completion of the transfer; and generating, by the DLT application by triggering execution of a ledger agent, an update instruction that causes, using the second communication protocol, the one or more nodes to add a record of the transfer to the distributed ledger, thereby updating the DLT-based client destination.

In some aspects, the techniques described herein relate to a method, further including: receiving, by the DLT application by triggering execution of an interfacing agent via a chat interface with a user of the client device, a user input requesting the transfer from the source to the DLT-based client destination.

In some aspects, the techniques described herein relate to a method, wherein generating the modified transfer instruction includes: detecting, by the DLT application by triggering execution of a conflict detection agent, whether the user input contains errors; and generating, by the DLT application by triggering execution of the instruction generation agent, the modified transfer instruction responsive to the conflict detection agent determining one of: no errors are detected, or detected errors have been corrected.

In some aspects, the techniques described herein relate to a method, further including: responsive to detecting one or more errors in the user input: requesting, by the DLT application by triggering execution of the interfacing agent via the chat interface, additional data to correct the one or more errors; and after receiving the additional data, generating, by the DLT application by triggering execution of the interfacing agent, the modified transfer instruction after the conflict detection agent confirms the additional data corrects the one or more errors.

In some aspects, the techniques described herein relate to a method, wherein generating the modified transfer instruction includes: using, by the DLT application by triggering execution of the instruction generation agent, a mapping to identify the second destination based on the identifier of the DLT-based client destination.

In some aspects, the techniques described herein relate to a method, wherein generating the modified transfer instruction includes: executing, by the DLT application by triggering execution of the instruction generation agent, an artificial intelligence model to identify the second destination based on the identifier of the DLT-based client destination.

In some aspects, the techniques described herein relate to a method, including: receiving, by the DLT application from the client device and using the first communication protocol, a message initiating the transfer; and transmitting, by the DLT application, subsequent messages with the client device or a second client device using the second communication protocol.

In some aspects, the techniques described herein relate to a method, wherein determining that the conversion is required includes executing, by the DLT application by triggering execution of the conversion agent, a large language model using the transfer instruction to generate an output indicating the conversion is required.

In some aspects, the techniques described herein relate to a method, further including: receiving, by the DLT application from a second client device and using the first communication protocol, a second transfer instruction for a second transfer; and responsive to determining, by the DLT application by triggering execution of the conversion agent, a conversion is not required for the second transfer, and further responsive to receipt of a third transfer instruction matching the second transfer instruction, initiating, by the DLT application, the second transfer.

In some aspects, the techniques described herein relate to a method, further including transmitting, by the DLT application, the modified transfer instruction to the application using the first communication protocol, wherein the application causes the transfer based on the modified transfer instruction.

In some aspects, the techniques described herein relate to a method, wherein two or more of the conversion agent, the instruction generation agent, or the ledger agent are the same agent.

In some aspects, the techniques described herein relate to a system for enabling transfers across different communication protocols using distributed ledger technology (DLT), the system including: an application server including a processor executing or hosting a DLT application, the processor configured to execute or host the DLT application to: receive, from a client device, a transfer instruction configured for transmission to an application executed by a computing system to transfer from a source in the computing system to a DLT-based client destination, the transfer instruction including an identifier of the source and an identifier of the DLT-based client destination; responsive to determining, by triggering execution of a conversion agent, that a conversion is required for the transfer, generate, by triggering execution of an instruction generation agent, a modified transfer instruction including an identifier of a second destination replacing the DLT-based client destination; receive, using a first communication protocol and from the application, an indication of completion of the transfer; and generate, by triggering execution of a ledger agent, an update instruction that causes, using a second communication protocol, one or more nodes hosting a distributed ledger to add a record of the transfer to the distributed ledger, thereby updating the DLT-based client destination.

In some aspects, the techniques described herein relate to a system, wherein the processor is further configured to receive, by triggering execution of an interfacing agent via a chat interface with a user of the client device, a user input requesting the transfer from the source to the DLT-based client destination.

In some aspects, the techniques described herein relate to a system, wherein the processor is further configured to execute or host the DLT application to generate the modified transfer instruction by: detecting, by triggering execution of a conflict detection agent, whether the user input contains errors; and generating, by triggering execution of the instruction generation agent, the modified transfer instruction responsive to the conflict detection agent determining one of: no errors are detected, or detected errors have been corrected.

In some aspects, the techniques described herein relate to a system, wherein the processor is further configured to: responsive to detecting one or more errors in the user input: request, by triggering execution of the interfacing agent via the chat interface, additional data to correct the one or more errors; and after receiving the additional data, generate, by triggering execution of the interfacing agent, the modified transfer instruction after the conflict detection agent confirms the additional data corrects the one or more errors.

In some aspects, the techniques described herein relate to a system, wherein the processor is configured to generate the modified transfer instruction by using, by triggering execution of the instruction generation agent, a mapping to identify the second destination based on the identifier of the DLT-based client destination.

In some aspects, the techniques described herein relate to a system, wherein the processor is configured to generate the modified transfer instruction by executing, by triggering execution of the instruction generation agent, an artificial intelligence model to identify the second destination based on the identifier of the DLT-based client destination.

In some aspects, the techniques described herein relate to a system, wherein the processor is configured to: receive, from the client device and using the first communication protocol, a message initiating the transfer; and transmit subsequent messages with the client device or a second client device using the second communication protocol.

In some aspects, the techniques described herein relate to a system, wherein the processor is configured to determine that the conversion is required by executing, by triggering execution of the conversion agent, a large language model using the transfer instruction to generate an output indicating the conversion is required.

In some aspects, the techniques described herein relate to a system, wherein the processor is further configured to: receive, from a second client device and using the first communication protocol, a second transfer instruction for a second transfer; and responsive to determining, by triggering execution of the conversion agent, a conversion is not required for the second transfer, and further responsive to receipt of a third transfer instruction matching the second transfer instruction, initiating the second transfer.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for enabling transfers across different communication protocols using distributed ledger technology (DLT), comprising:
establishing, by a DLT application executed by one or more processors, a first connection using a first communication protocol to an application executed by a computing system, and a second connection using a second communication protocol to one or more nodes hosting a distributed ledger;
receiving, by the DLT application and from a client device, a transfer instruction configured for transmission to the application to transfer from a source in the computing system to a DLT‑based client destination, the transfer instruction comprising an identifier of the source and an identifier of the DLT‑based client destination;
responsive to determining, by the DLT application by triggering execution of a conversion agent, that a conversion is required for the transfer,
generating, by the DLT application by triggering execution of an instruction generation agent, a modified transfer instruction comprising an identifier of a second destination replacing the DLT-based client destination;
receiving, by the DLT application using the first communication protocol and from the application, an indication of completion of the transfer; and
generating, by the DLT application by triggering execution of a ledger agent, an update instruction that causes, using the second communication protocol, the one or more nodes to add a record of the transfer to the distributed ledger, thereby updating the DLT‑based client destination.

2. The method of claim 1, further comprising:
receiving, by the DLT application by triggering execution of an interfacing agent via a chat interface with a user of the client device, a user input requesting the transfer from the source to the DLT-based client destination.

3. The method of claim 2, wherein generating the modified transfer instruction comprises:
detecting, by the DLT application by triggering execution of a conflict detection agent, whether the user input contains errors; and
generating, by the DLT application by triggering execution of the instruction generation agent, the modified transfer instruction responsive to the conflict detection agent determining one of:
no errors are detected, or
detected errors have been corrected.

4. The method of claim 3, further comprising:
responsive to detecting one or more errors in the user input:
requesting, by the DLT application by triggering execution of the interfacing agent via the chat interface, additional data to correct the one or more errors; and
after receiving the additional data, generating, by the DLT application by triggering execution of the interfacing agent, the modified transfer instruction after the conflict detection agent confirms the additional data corrects the one or more errors.

5. The method of claim 1, wherein generating the modified transfer instruction comprises:
using, by the DLT application by triggering execution of the instruction generation agent, a mapping to identify the second destination based on the identifier of the DLT-based client destination.

6. The method of claim 1, wherein generating the modified transfer instruction comprises:
executing, by the DLT application by triggering execution of the instruction generation agent, an artificial intelligence model to identify the second destination based on the identifier of the DLT-based client destination.

7. The method of claim 1, comprising:
receiving, by the DLT application from the client device and using the first communication protocol, a message initiating the transfer; and
transmitting, by the DLT application, subsequent messages with the client device or a second client device using the second communication protocol.

8. The method of claim 1, wherein determining that the conversion is required comprises executing, by the DLT application by triggering execution of the conversion agent, a large language model using the transfer instruction to generate an output indicating the conversion is required.

9. The method of claim 1, further comprising:
receiving, by the DLT application from a second client device and using the first communication protocol, a second transfer instruction for a second transfer; and
responsive to determining, by the DLT application by triggering execution of the conversion agent, a conversion is not required for the second transfer, and further responsive to receipt of a third transfer instruction matching the second transfer instruction, initiating, by the DLT application, the second transfer.

10. The method of claim 1, further comprising transmitting, by the DLT application, the modified transfer instruction to the application using the first communication protocol, wherein the application causes the transfer based on the modified transfer instruction.

11. The method of claim 1, wherein two or more of the conversion agent, the instruction generation agent, or the ledger agent are the same agent.

12. A system for enabling transfers across different communication protocols using distributed ledger technology (DLT), the system comprising:
an application server comprising a processor executing or hosting a DLT application, the processor configured to execute or host the DLT application to:
receive, from a client device, a transfer instruction configured for transmission to an application executed by a computing system to transfer from a source in the computing system to a DLT‑based client destination, the transfer instruction comprising an identifier of the source and an identifier of the DLT‑based client destination;
responsive to determining, by triggering execution of a conversion agent, that a conversion is required for the transfer,
generate, by triggering execution of an instruction generation agent, a modified transfer instruction comprising an identifier of a second destination replacing the DLT-based client destination;
receive, using a first communication protocol and from the application, an indication of completion of the transfer; and
generate, by triggering execution of a ledger agent, an update instruction that causes, using a second communication protocol, one or more nodes hosting a distributed ledger to add a record of the transfer to the distributed ledger, thereby updating the DLT‑based client destination.

13. The system of claim 12, wherein the processor is further configured to receive, by triggering execution of an interfacing agent via a chat interface with a user of the client device, a user input requesting the transfer from the source to the DLT-based client destination.

14. The system of claim 13, wherein the processor is further configured to execute or host the DLT application to generate the modified transfer instruction by:
detecting, by triggering execution of a conflict detection agent, whether the user input contains errors; and
generating, by triggering execution of the instruction generation agent, the modified transfer instruction responsive to the conflict detection agent determining one of:
no errors are detected, or
detected errors have been corrected.

15. The system of claim 14, wherein the processor is further configured to:
responsive to detecting one or more errors in the user input:
request, by triggering execution of the interfacing agent via the chat interface, additional data to correct the one or more errors; and
after receiving the additional data, generate, by triggering execution of the interfacing agent, the modified transfer instruction after the conflict detection agent confirms the additional data corrects the one or more errors.

16. The system of claim 12, wherein the processor is configured to generate the modified transfer instruction by using, by triggering execution of the instruction generation agent, a mapping to identify the second destination based on the identifier of the DLT-based client destination.

17. The system of claim 12, wherein the processor is configured to generate the modified transfer instruction by executing, by triggering execution of the instruction generation agent, an artificial intelligence model to identify the second destination based on the identifier of the DLT-based client destination.

18. The system of claim 12, wherein the processor is configured to:
receive, from the client device and using the first communication protocol, a message initiating the transfer; and
transmit subsequent messages with the client device or a second client device using the second communication protocol.

19. The system of claim 12, wherein the processor is configured to determine that the conversion is required by executing, by triggering execution of the conversion agent, a large language model using the transfer instruction to generate an output indicating the conversion is required.

20. The system of claim 12, wherein the processor is further configured to:
receive, from a second client device and using the first communication protocol, a second transfer instruction for a second transfer; and
responsive to determining, by triggering execution of the conversion agent, a conversion is not required for the second transfer, and further responsive to receipt of a third transfer instruction matching the second transfer instruction, initiating the second transfer.
